(19) United States
(12) Patent Application Publication
(10) Pub. No.: US 2014/0152806 A1
(43) Pub. Date: Jun. 5, 2014

(54) AUTOMATED STUDIO

(71) Applicant: Sharp Cars Detailing & More, LLC, O'Fallon, MO (US)

(72) Inventor: Jason Hauk, O'Fallon, MO (US)

(73) Assignee: Sharp Cars Detailing & More, LLC, O'Fallon, MO (US)

(21) Appl. No.: 14/088,939

(22) Filed: Nov. 25, 2013

Related U.S. Application Data
(60) Provisional application No. 61/732,078, filed on Nov. 30, 2012.
(60) Provisional application No. 61/792,258, filed on Mar. 15, 2013.

(51) Int. Cl. G06T 19/00

(52) U.S. Cl. CPC G06T 19/006
USPC 348/121

(57) ABSTRACT

An automated studio acquires photographs and/or videos of vehicles and makes them available on the Internet via a virtual showroom. The automated studio comprises a mobile cart and cameras for acquiring images of the vehicle, a computer for automating the image and information acquisition processes, a database for storing the images and information, and a virtual showroom for presenting the acquired images and information. The automated studio further comprises a turntable for rotating a vehicle and at least one camera for acquiring images of the vehicle while it is rotating.

### CROSS-REFERENCE TO RELATED APPLICATIONS

This application claims the benefit of U.S. Provisional Application Ser. No. 61/792,258, filed Mar. 15, 2013, and U.S. Provisional Application Ser. No. 61/732,078, filed Nov. 30, 2012, the entire disclosures of which are incorporated herein by reference for all purposes.

### BACKGROUND

Consumers usually purchase vehicles in one of two ways. The first, a traditional approach, involves visiting a dealer's lot, listening to a salesperson's pitch, test driving a selected vehicle, and then haggling over price. This approach advantageously provides consumers an opportunity to view the particular vehicle in-person and receive a hands-on demonstration of the vehicle's features and options. However, this approach is time-consuming and interacting with a salesperson can be intimidating for many consumers.

The second approach involves a “virtual showroom” where consumers can research and price vehicles on the Internet. This approach advantageously allows consumers to search for vehicles in less time and with less salesperson interaction than the traditional approach. Unfortunately, when visiting a virtual dealership, consumers are often limited to stock photographs and generic information and must forego the more traditional “walk around” experience. Current systems and methods of acquiring photographs and/or videos of vehicles and making them available on the Internet are labor-intensive and require skillful use of technologically advanced devices. Consequently, even if actual photographs and/or videos of a particular vehicle are available, they are often limited in scope and unable to properly convey how the vehicle appears in-person. In addition, the information available about the vehicle is often non-specific and relates generally to a make and model rather than specifically to the particular vehicle. In other words, consumers are forced to sacrifice advantageous aspects of the traditional vehicle purchasing approach in order to enjoy the convenience and other advantages of the virtual showroom approach.

Moreover, many virtual dealerships often employ a “no haggle” pricing model. As a result, it becomes important for virtual dealers to make a high volume of sales. A virtual dealership attempting to make a high volume of sales must quickly acquire information about vehicles in its inventory, including photographs and/or videos of the vehicles, and make that information available to consumers on the Internet. Conventional systems and methods are unable to acquire photographs and/or videos of vehicles and post them on the Internet with the necessary throughput to keep up with the quick turnaround of high volume sales.

### SUMMARY

In accordance with aspects of the invention, an automated studio collects photographs and/or videos of vehicles and makes them available on the Internet. An aspect of this end-to-end solution captures images and other information of a particular vehicle, processes and stores the images and information, and adds the vehicle to a virtual showroom, which presents the vehicle inventory. This aspect of the solution provides consumers with ample information about the particular vehicles available in the inventory along with the traditional benefits of a virtual showroom. Further, this aspect of the solution provides sellers with a user-friendly and quick (e.g., 7 minutes or less per vehicle) way of acquiring images and information of a particular vehicle and creating a virtual showroom to display the vehicle. This aspect makes high-volume “no-haggle” sales tactics economical to employ. In an aspect, the automated studio provides simplicity and portability and employs software that can be utilized across multiple sites and is easy to use, install, and support.

In an aspect, a system for rendering a virtual vehicle showroom comprises a turntable adapted for receiving a vehicle on a rotatable platform, at least one camera for acquiring one or more images of the vehicle, and a database for storing the acquired images and corresponding information. Further, a computer executes computer-executable instructions for rendering a virtual showroom user interface for presenting the acquired images and the corresponding information.

A method for rendering a virtual vehicle showroom embodying aspects of the invention includes acquiring one or more images of a vehicle while the vehicle is present upon a turntable having a rotatable platform for supporting the vehicle, storing the acquired images and corresponding information in a database, and executing computer-executable instructions for rendering a virtual showroom user interface for presenting the acquired images and the corresponding information.

In another aspect, a system comprises at least one image capturing component operative to acquire one or more images of a vehicle located upon a turntable having a rotatable platform for supporting the vehicle. The system further includes a first computer executing computer-executable instructions to display a systematic procedure for acquiring the one or more images, receive commands for acquiring the one or more images, and execute the received commands to manipulate the at least one image capturing component and the turntable to acquire the one or more images. The system also includes a database component operative to maintain a database identifying the imaged vehicles and their corresponding images and vehicle information and a second computer. The second computer executes computer-executable instructions to render a virtual showroom user interface for presenting the vehicles, acquired images, and corresponding information.

In another aspect, a system comprises a cart that has a support arm affixed thereto. A linear motion member on the self-locomotive cart manipulates the support arm. The system also includes an electrical power source on the cart, a plurality of cameras mounted on the support arm, at least one light source, and at least one wireless communications transceiver. The at least one wireless communications transceiver transmits the images acquired by the cameras and other information and receives control communications.

In another aspect, a system comprises a mobile cart that supports a plurality of cameras for acquiring one or more images of a vehicle. In addition, the system has an electrical power source and at least one wireless communications transceiver. The system also includes a database for storing the acquired images and corresponding information and a computer. The computer executes computer-executable instructions for rendering a virtual showroom user interface for presenting the acquired images and the corresponding information to a user.

### BRIEF DESCRIPTION OF THE DRAWINGS

FIG. 1 is a diagram of an automated studio comprised of various components in accordance with an embodiment of the invention.

FIG. 2 illustrates a turntable within an imaging space in accordance with an embodiment of the invention.

FIG. 3 further illustrates the imaging space of FIG. 2.

FIG. 4 illustrates a camera in accordance with an embodiment of the invention.

FIG. 5 illustrates an imaging apparatus comprised of cameras, a support arm, and a linear motion member in accordance with an embodiment of the invention.

FIG. 6 illustrates a camera and light source for use in the imaging apparatus of FIG. 5.

FIG. 7 illustrates a linear motion member in accordance with an embodiment of the invention.

FIG. 8 is an exemplary screenshot of a virtual showroom in accordance with an embodiment of the invention.

FIGS. 9A-C, 10A-D, 11A-D, 12A-F, 13A-F, 14A-B illustrate a user interface wizard in accordance with an embodiment of the invention.

FIG. 15 is a diagram of a computing environment in which aspects of the invention may be implemented.

### DETAILED DESCRIPTION

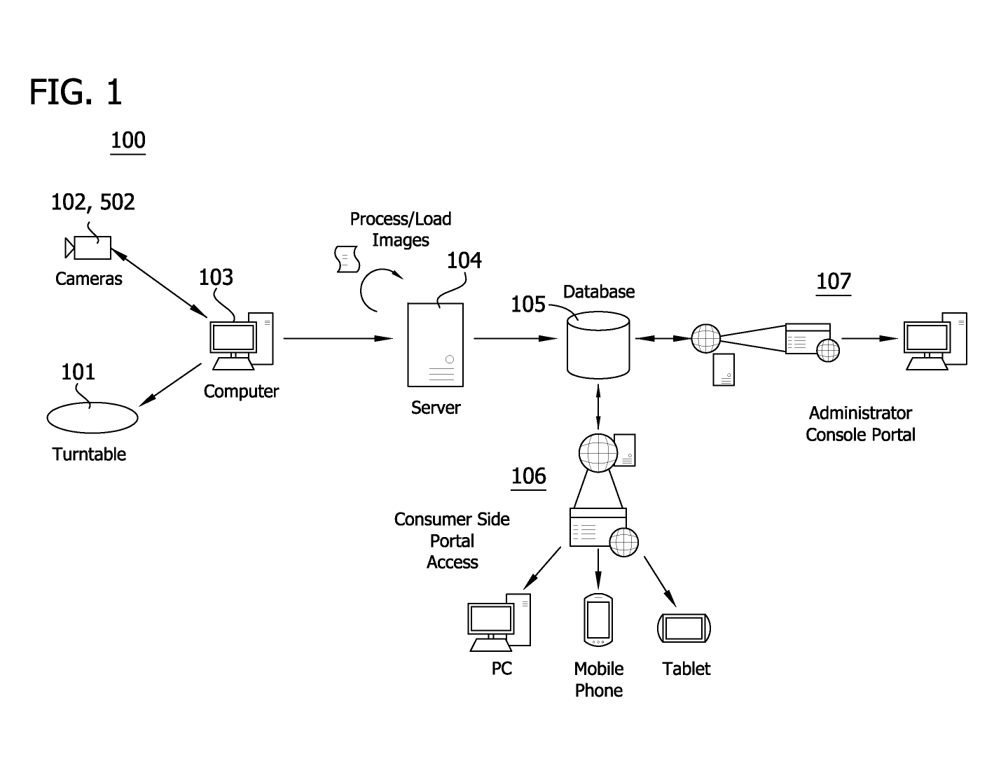

FIG. 1 illustrates an automated studio embodying aspects of the present invention. In accordance with aspects of the present invention, the automated studio collects photographs and/or videos of vehicles and makes them available on the Internet.

By contrast, a dealer or seller otherwise has to walk around to each vehicle with a camera, or other imaging device, and photograph the vehicle. Acquiring images of the exterior from various vantage points requires the seller to move the vehicle to an open space with sufficient room on all sides, walk around the vehicle, and manually acquire the images. Often, several images need to be acquired from each location to account for some images turning out blurry or having bad lighting conditions. Acquiring images of the interior requires the dealer to open various doors of the vehicle, get inside, and perhaps reach or climb over seats or other equipment inside the vehicle. Acquisition of multiple images is needed for the same reasons as above. After parking the vehicle back in its original spot, the dealer must take the imaging device and connect it a computer or otherwise manually transfer the images from the camera to a computer. The dealer must then sort through the various images to select the preferred ones and upload them to a server. Finally, a webpage must be updated or created to include links or references to the new vehicle images and textual information about the vehicle must be manually entered. Such a conventional method requires the dealer to spend time that could otherwise be spent on other aspects of the business and requires knowledge about photography, electronic devices, computers, and website coding and design.

Stock images and generic information can be used to reduce the amount of time a dealer has to spend acquiring images and information. But stock images and generic information do not provide a consumer with information about the particular vehicle the dealer is selling. Moreover, the use of stock photos does not alleviate the dealer need for knowledge about computers and website coding and design. Additionally, the time it typically takes to manually update a webpage with new vehicle images and information is too long to adequately sell vehicles at a high enough volume to make “no haggle” pricing effective.

The automated studio 100 embodied in FIG. 1 comprises a turntable 101, one or more cameras 102, 502, a computer 103, a server 104, a database 105, a consumer-side portal access 106, and an administrator console portal 107. In this end-to-end solution, images of a particular vehicle are acquired, processed, stored, and used to create an entry for the vehicle on an online inventory of vehicles, all with minimal human effort and in a short enough period of time (e.g., 7 minutes or less per vehicle) to make a high volume of sales possible. In an aspect, the automated studio provides simplicity and portability and employs software that can be utilized across multiple sites and platforms and is easy to use, install, and support. Contemplated vehicles include, by way of example and not limitation, automobiles, boats, personal watercraft (e.g., Jet Ski), recreational vehicles (RV), motorcycles, all-terrain vehicles (ATV), trailers, and the like.

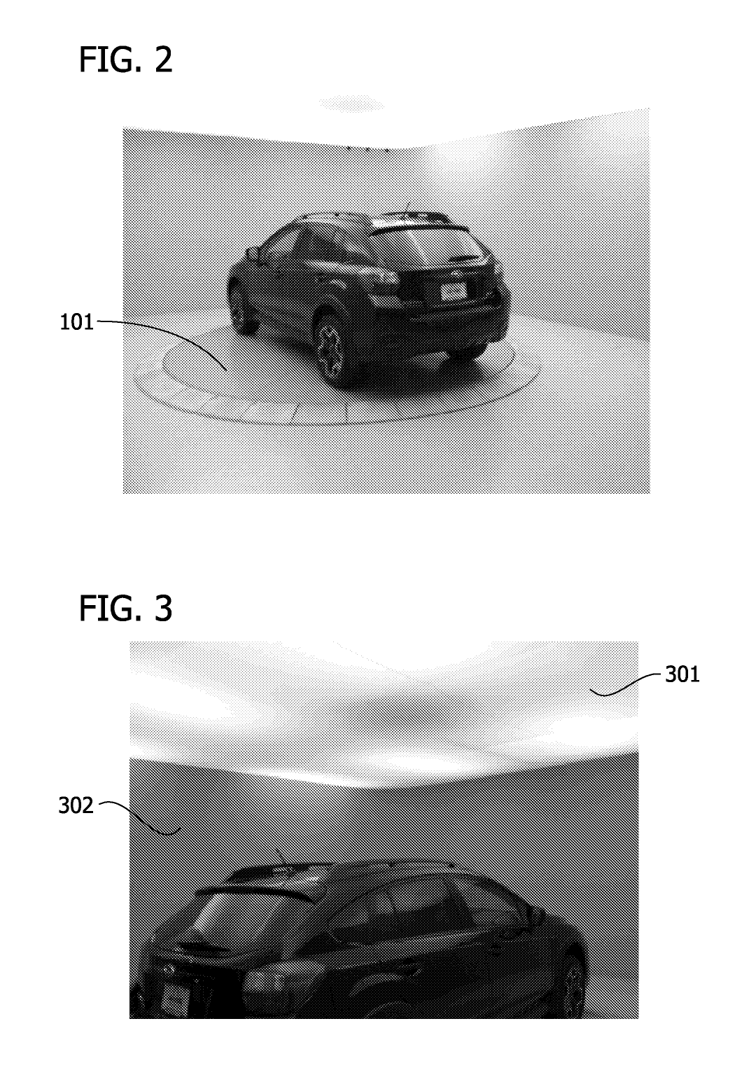

The turntable 101 comprises a rotatable platform adapted for receiving and supporting a vehicle and rotating the vehicle 360 degrees as well as portions and iterations thereof. According to aspects of the invention, a relay provides an interface between turntable 101 and computer 103 or a communications network transmitting control information. Upon receiving an appropriate command or control signal from computer 103 or communications network, turntable 101 rotates the desired angular distance at the desired angular velocity, thus rotating the vehicle a uniform distance and at a uniform velocity. FIG. 2 illustrates turntable 101 supporting a vehicle and located within an enclosure having a ceiling and walls, further described below.

Referring again to the embodiment illustrated by FIG. 1, cameras 102 are adapted for acquiring images of a vehicle supported by turntable 101, preferably as the vehicle rotates via turntable 101. The cameras 502 are adapted for acquiring images of a vehicle through the use of imaging apparatus 500, further described below. As used herein, images include still photographs (e.g., snap shots), moving photographs (e.g., videos or movies), panoramics, stereoscopic photographs, or any combination thereof. In addition to acquiring images of an entire vehicle, images of only a portion of a vehicle may also be acquired. For example, images may be taken only of the vehicle's identification number (VIN), text identifying the model of the vehicle, or any areas of the vehicle that are particularly noteworthy, such as scratches, dents, add-ons, tire treads, and the like. It is also contemplated that a salesperson can provide a video demonstration of the vehicle's features and options to be integrated into the final virtual showroom. The video “sales pitch” can be made while the vehicle is rotating via turntable 101 or stationary.

The cameras 102, 502 preferably include one or more Internet protocol (IP) cameras adapted for connecting to a telecommunications network, for example one utilizing the Internet Protocol communications protocol, such as the Internet. It is also contemplated that cameras 102, 502 are capable of directly coupling to a computing device via a relay or a communications channel employing serial and/or parallel communications methods. The cameras 502 preferably utilize a wide-angle lens, including, by way of example and not limitation, a fisheye lens. Suitable IP cameras are available from GeoVision, Inc. Arecont Vision provides suitable IP video cameras and associated software. HouseLinc, available from Insteon, is a suitable relay for managing and interfacing cameras 102, 502. The present embodiment also contemplates the use of one or more handheld cameras. In addition, various filters, such as polarizing filters, may be employed on cameras 102, 502 for improving image quality.

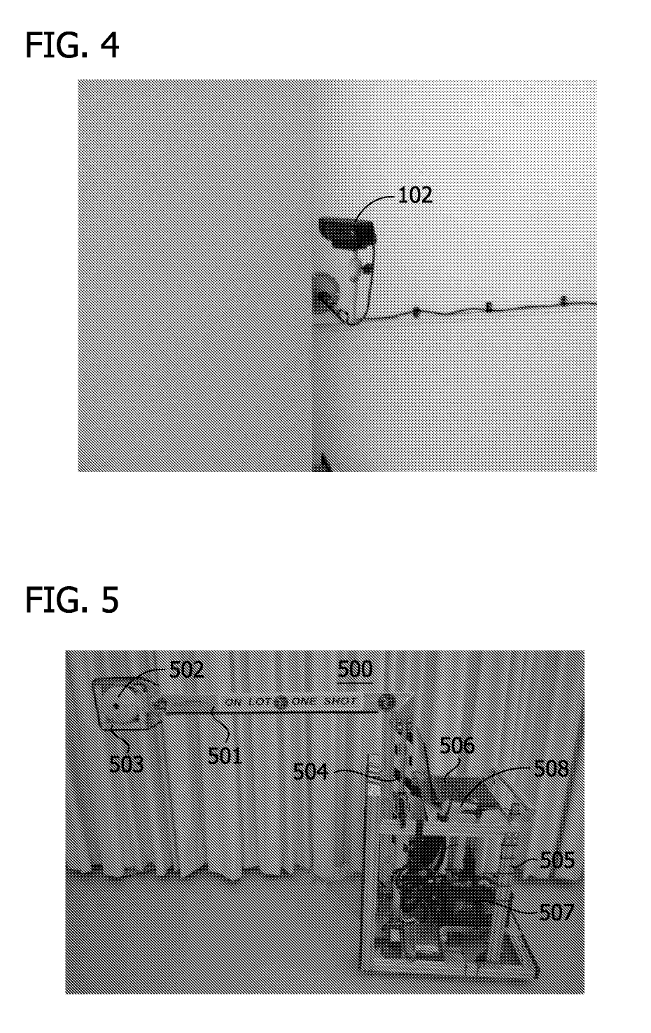

In an embodiment illustrated by FIG. 4, at least one of cameras 102 is located at a fixed position outside the circumference of turntable 101 and is pointed towards the center of turntable 101. The fixed camera 102 is preferably affixed at a height between five feet and six and one-half feet above turntable 101 to provide a view from the perspective of an average consumer if the consumer were viewing the vehicle in-person. As turntable 101 rotates the vehicle, fixed camera 102 acquires images of the vehicle's exterior. Advantageously, software on cameras 102, computer 103, server 104, or any combination thereof, is capable of automatically stitching the acquired images together to form a continuous image that accurately depicts a 360-degree view of the exterior of the vehicle.

FIG. 5 illustrates an imaging apparatus 500 embodying aspects of the present invention. In an embodiment, imaging apparatus 500 is adapted for positioning cameras 502 and light sources 503 (e.g., LEDs) inside a vehicle to acquire images of the vehicle's interior and for transmitting the images to a server or database. In another embodiment, imaging apparatus 500 is adapted for positioning cameras 502 and light sources 503 at various locations around the perimeter of the vehicle to acquire images of the vehicle's exterior and for transmitting the images to a server or database. The imaging apparatus 500 comprises a mobile cart 505, a support arm 501, a linear motion member 504, one or more cameras 502, one or more light sources 503, a barcode scanner 508, one or more wireless communications transceivers 506, and an electric power source 507. Advantageously, an embodiment of imaging apparatus 500 allows acquisition of images of the interior of the particular vehicle being added to the online inventory, rather than using stock images.

The mobile cart 505 is adapted for providing a support structure upon which to affix various components of imaging apparatus 500 and a means with which to position imaging apparatus 500 relative to the vehicle. The mobile cart 505 is comprised of rigid members assembled together to create a frame-like structure. By way of example and not limitation, mobile cart 505 may be comprised of pieces of aluminum welded or bolted together. The mobile cart 505 may have a padding material, such as foam, affixed to the rigid material to provide a buffer that prevents the rigid material from scratching the vehicle during use. The frame-like structure of mobile cart 505 may also be enclosed to make imaging apparatus 500 waterproof and shockproof. Other components of imaging apparatus 500 may be permanently or temporarily affixed to the frame structure of mobile cart 505, which provides portability and self-containment for imaging apparatus 500.

During use according to one embodiment, a user manually moves mobile cart 505 to position imaging apparatus 500 relative to the vehicle, such as to position cameras 502 inside the vehicle having a view of substantially the entire interior. In another embodiment, mobile cart 505 self-locomotes via a motor, which drives a device that enables movement of imaging apparatus 500 across a surface. By way of example and not limitation, an electric motor drives wheels, skid-steer tracks, or the like to move imaging apparatus 500 across a surface to position imaging apparatus 500 relative to the vehicle. In another embodiment, mobile cart 505 remains stationary while support arm 501 is positioned relative to the vehicle. Advantageously, a user familiar with the system can acquire the images needed to generate a 360 degree view of the vehicle's interior in a short amount of time (e.g., less than 2 minutes).

In an embodiment, support arm 501 is adapted for providing an extension to position cameras 502 and light sources 503 inside the vehicle while keeping the other components of imaging apparatus 500 outside the vehicle. In another embodiment, support arm 501 is adapted for providing an extension to position cameras 502 and light sources 503 at various points around the exterior of the vehicle, such as above or below the vehicle. The support arm 501 is comprised of rigid members assembled together. The support arm 501 may be comprised of pieces of the same material as cart 505 or may be comprised of different materials. The support arm 501 is of such a thickness that it does not readily appear in stitched-together images acquired, for example, from inside the vehicle. An exemplary thickness of support arm 501 is 1⅞ inches.

The support arm 501 has a portion that extends in a vertical direction and a portion that extends in a horizontal direction and is affixed at some point to cart 505. By way of example and not limitation, support arm 501 may extend vertically upward from cart 505 and then make a 90 degree bend and extend horizontally away from cart 505. In an embodiment, support arm 501 is one single, unitary piece. In another embodiment, support arm 501 is adapted for moving in a vertical direction by a linear motion member 504. The linear motion member 504 moves support arm 501 via a motor drive, such as a stepper motor drive. Advantageously, linear motion member 504 allows support arm 501 to be moved vertically so cameras 502 and light sources 503 can be positioned through an open window of the vehicle at varying heights. In another embodiment, support arm 501 telescopes in a vertical direction and/or a horizontal direction. Advantageously, the telescoping capability of support arm 501 allows imaging apparatus 500 to remain compact while providing the ability to position cameras 502 and light sources 503 a greater distance from mobile cart 505.

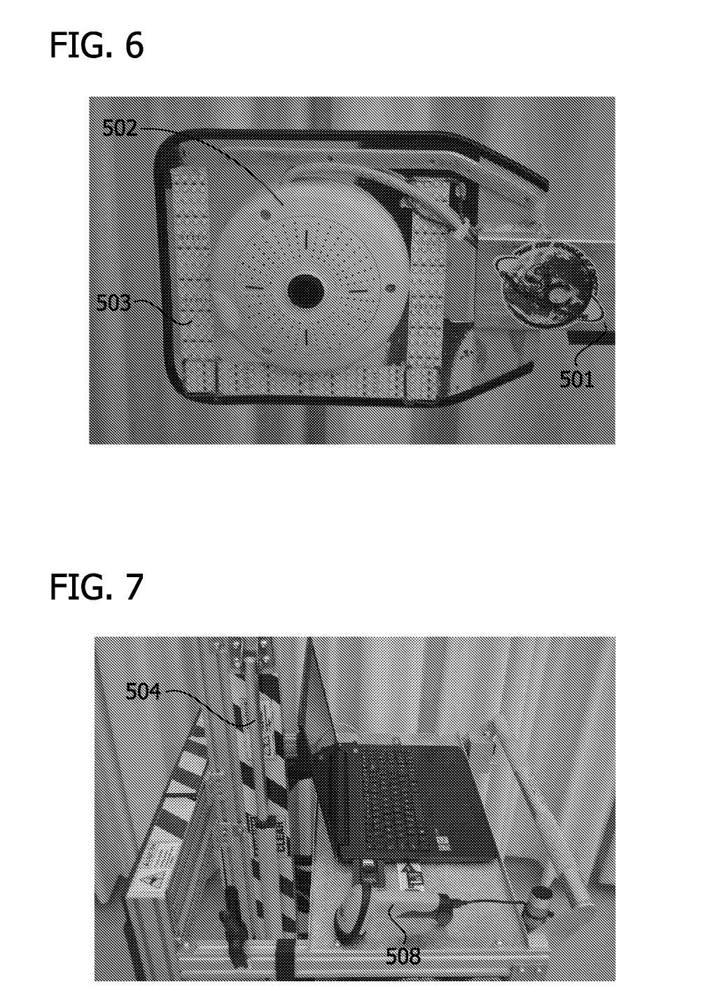

The one or more cameras 502 are adapted for acquiring images of the interior of the vehicle. In the embodiment of FIGS. 5 and 6, two cameras 502 having fisheye lenses are mounted back-to-back on the end of the horizontal portion of support arm 501 farthest from the vertical portion. Each fisheye camera 502 allows essentially a hemisphere of viewing and preferably converts the distorted hemispherical image into a conventional rectilinear projection. It is contemplated that other projections may be used, such as cylindrical, spherical, or other specialized projections. Advantageously, software on cameras 502, computer 103, server 104, or any combination thereof, automatically stitches the images together to form a continuous image that accurately depicts the interior of the vehicle.

The one or more light sources 503 are adapted for providing sufficient lighting conditions inside the vehicle for acquisition of the images. In the embodiment of FIGS. 5 and 6, light sources 503 are mounted on support arm 501 adjacent to cameras 502. Preferably, light sources 503 are comprised of light-emitting diodes.

Referring to FIG. 5, barcode scanner 508 is adapted for scanning the VIN of the vehicle. Advantageously, barcode scanner 508 is handheld and allows a user to collect the VIN without the need to manually enter the VIN into computer 103 or database 105. In an embodiment, acquiring the VIN will initiate the image acquisition process.

The one or more wireless communications transceivers 506 are adapted for transmitting acquired images to a server or database via a communications medium, such as the Internet. Additionally, wireless communications transceivers 506 are adapted for receiving control signals generated by computer 103 or another computing device via a communications medium, such as the Internet. The control signals provide information regarding the relative position of cart 505 with respect to the vehicle, regarding the vertical movement of support arm 501, and regarding the operation and manipulation of cameras 502 and light sources 503. The wireless communications transceivers 506 are affixed to cart 505 and may be any transceiver capable of receiving and/or transmitting communications signals. By way of example and not limitation, wireless communications transceivers 506 may operate according the IEEE 802.11 (WiFi) standard, the IEEE 802.15.1 (Bluetooth™) standard, may be a cellular network modem, or may be a laptop computer having wireless communications capabilities. A suitable cellular network modem is the 341U available from Netgear, Inc. Advantageously, wireless communications transceivers 506 allow the imaging apparatus to receive and send information without the need for wires and to operate in a variety of locations.

The electric power source 507 is adapted for providing electrical energy to power the various components of the imaging apparatus, including the electric motor of cart 505, the motor of linear motion member 504, cameras 502, light sources 503, and wireless communications transceivers 506. The electric power source 507 is affixed to cart 505. Preferably, electric power source 507 is a battery that can be recharged or replaced, such as, by way of example and not limitation, an automotive battery.

For superior imaging results, automated studio 100 employs several special features to reduce the likelihood of undesirable glare and shadows being present in the acquired images. In an embodiment illustrated by FIG. 3, automated studio 100 has an enclosed imaging space with a ceiling 301 having a height of at least 12 feet and covered in a light-colored fabric, such as Muslin cloth or the like. In the embodiment, automated studio 100 has at least one wall 302, which is preferably curved and painted a neutral color, such as gray. The floor and turntable 101, as illustrated in the embodiment of FIG. 2, are each of a color similar to the color of walls 302. A curtain provides an effective means for ingress and egress of vehicles while providing color uniformity. Fluorescent lamps, such as T5 lamps, are suitable to light the imaging space.

Moreover, automated studio 100 embodying aspects of the invention is especially well-suited for taking pictures to prevent glare and shadow, as well as special views, such as a “night shot” and a “ladder shot.”

Referring again to the embodiment in FIG. 1, automated studio 100 further comprises a computer 103. According to aspects of the invention, a relay provides an interface between the various components of the system and the computer 103. The computer 103 may connect to the relay via a telecommunications network or a communications channel employing serial and/or parallel communications methods. The computer 103 executes computer-readable instructions embodied in software, namely, an automatic photography application that integrates with cameras 102, 502, turntable 101, imaging apparatus 500, and relay. The computer 103 displays, on a graphical user interface (GUI), a systematic process for acquiring images of the vehicle, which may be on turntable 101, and receives commands from a user to acquire the images. The software, preferably stored on a non-transitory computer-readable medium, such as a memory device, implements the commands and acquires the images for use in generating the showroom experience by manipulating cameras 102, 502, imaging apparatus 500, and turntable 101.

In one embodiment, computer 103 executes a Windows Presentation Foundation (WPF) application on the .NET framework. The WPF application automates the process of acquiring images of the vehicle. Moreover, software integrates and controls the GeoVision, Arecont Vision, and HouseLinc relay. The GeoVision software development kit (SDK) and HouseLinc SDK, for example, integrate these two systems. An application programming interface (API), such as the open Arecont Vision API, controls the devices.

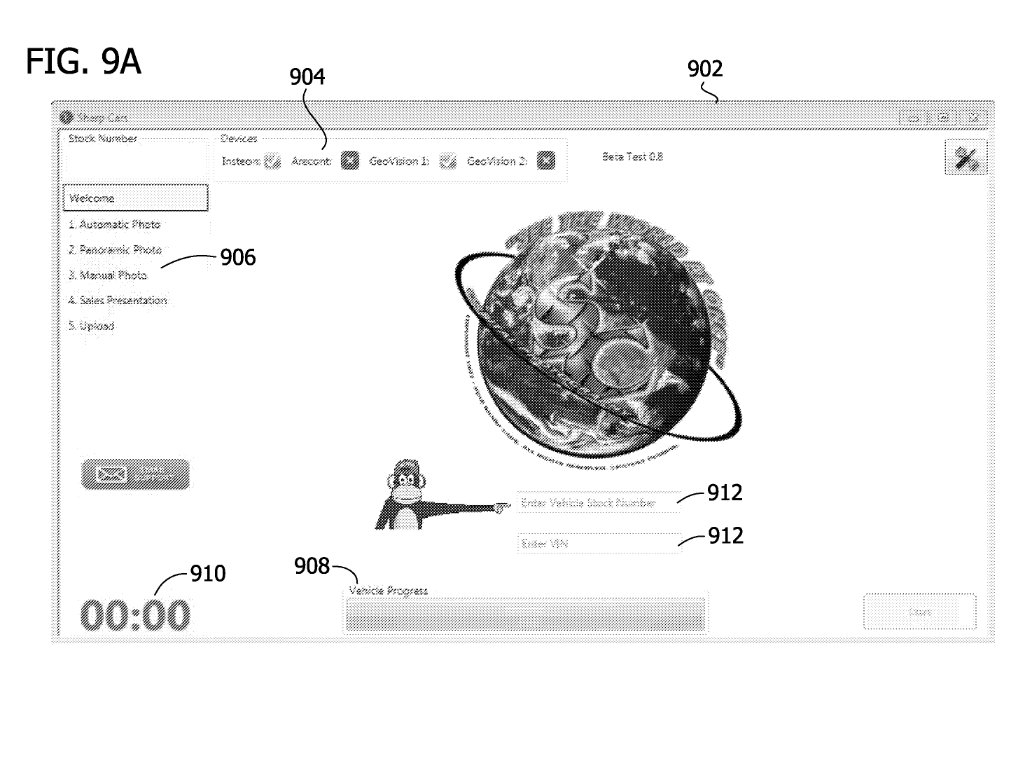

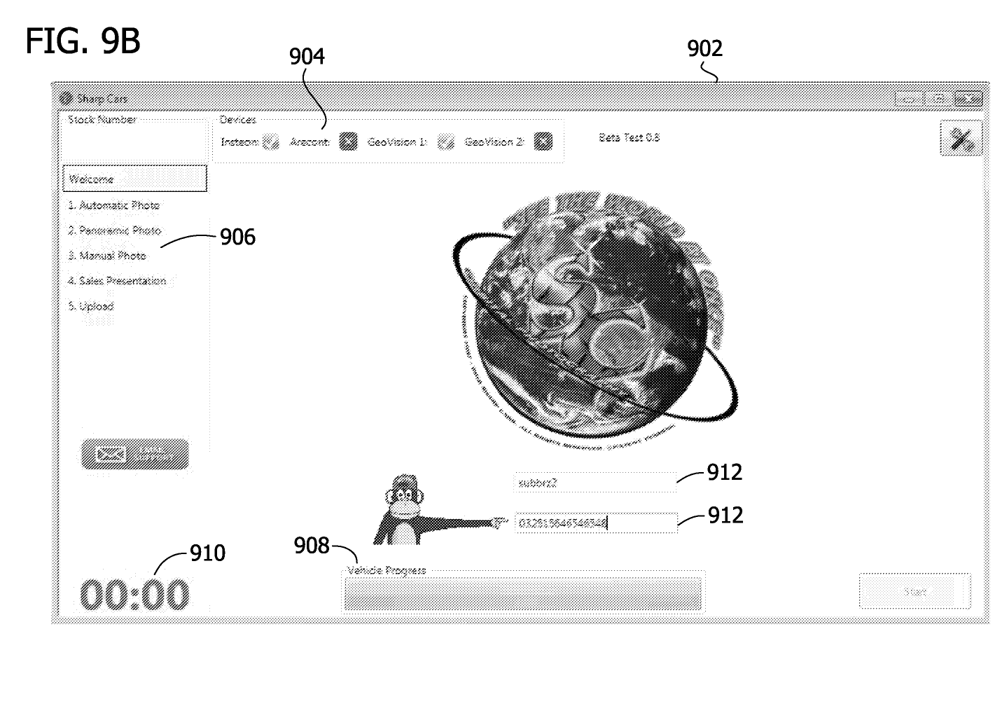

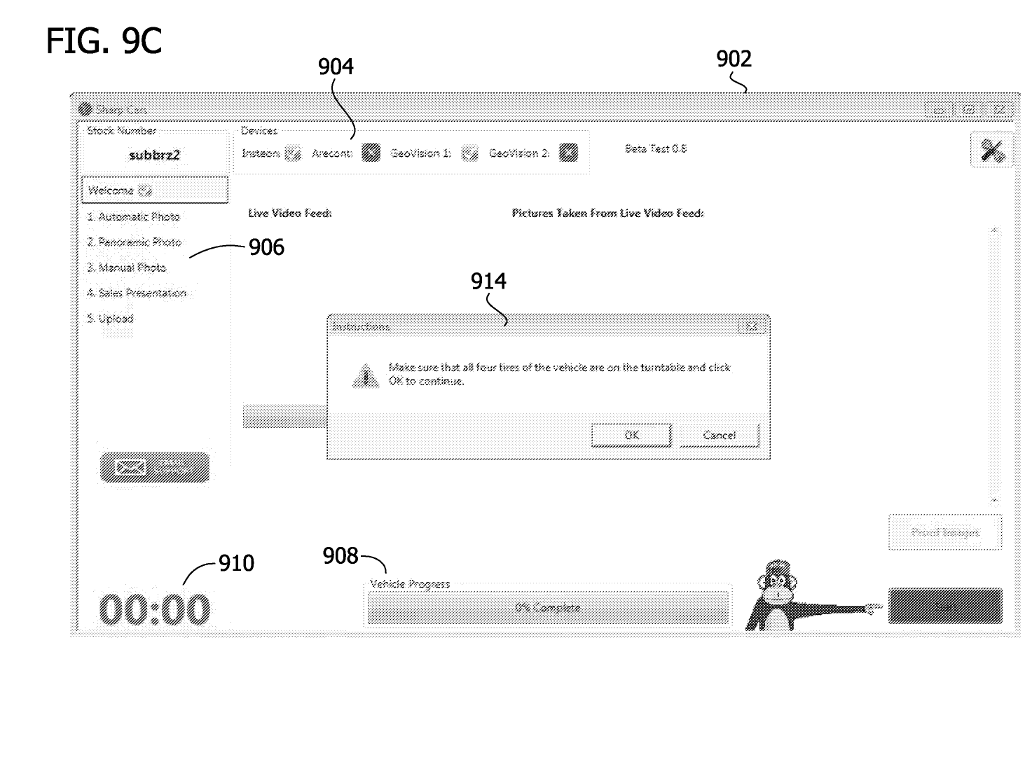

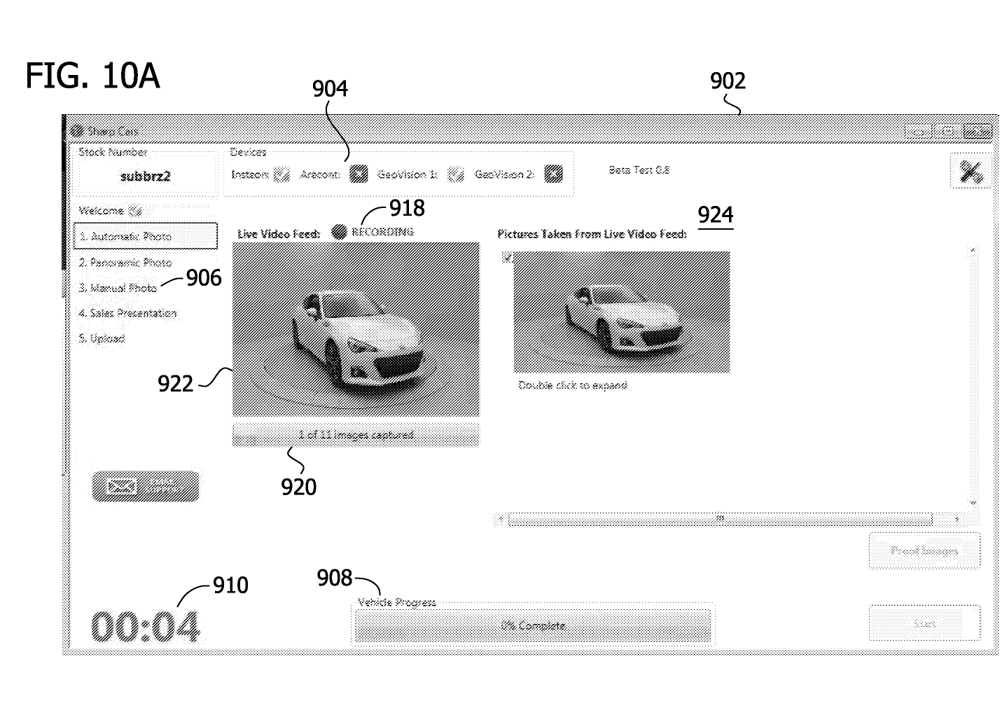

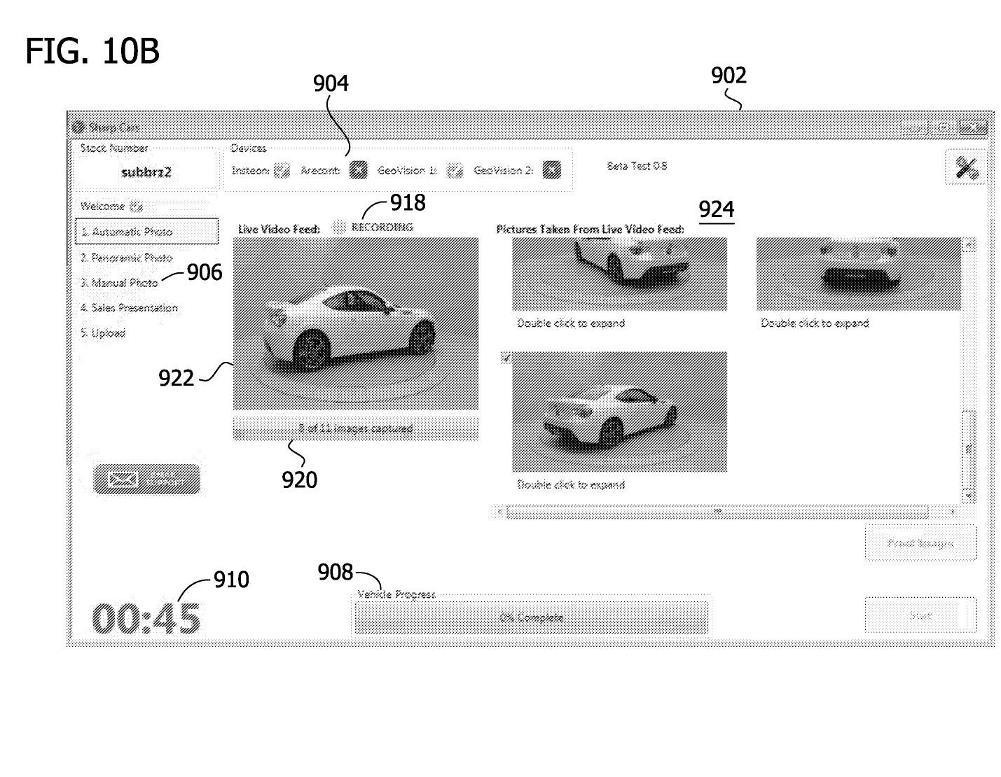

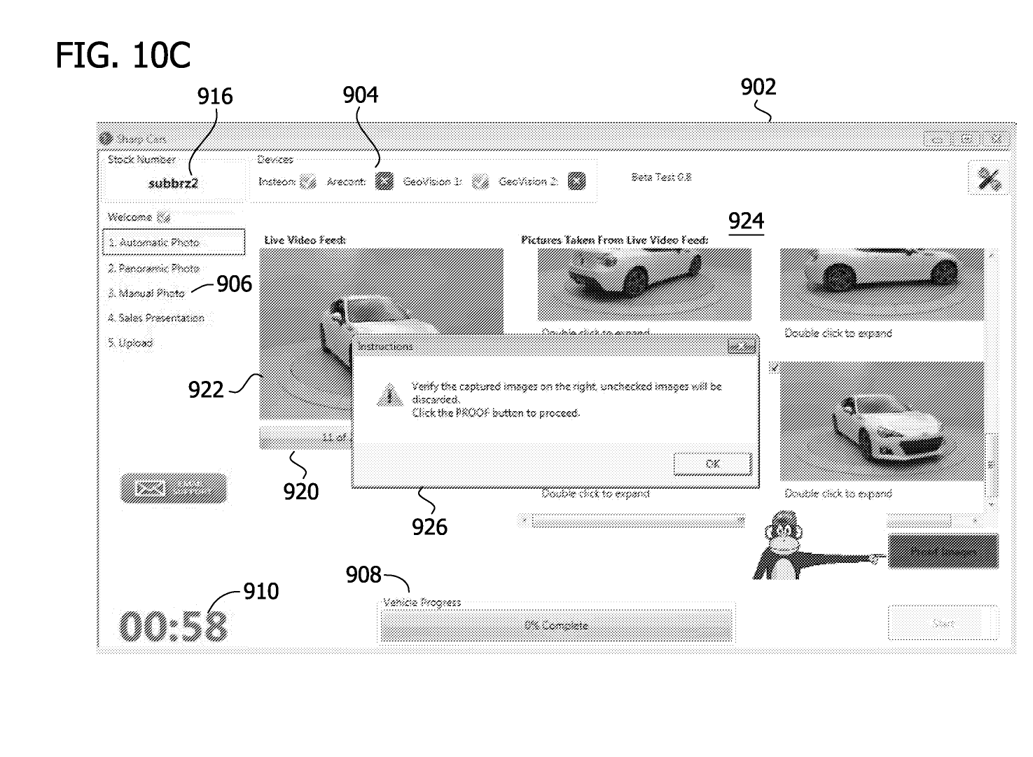

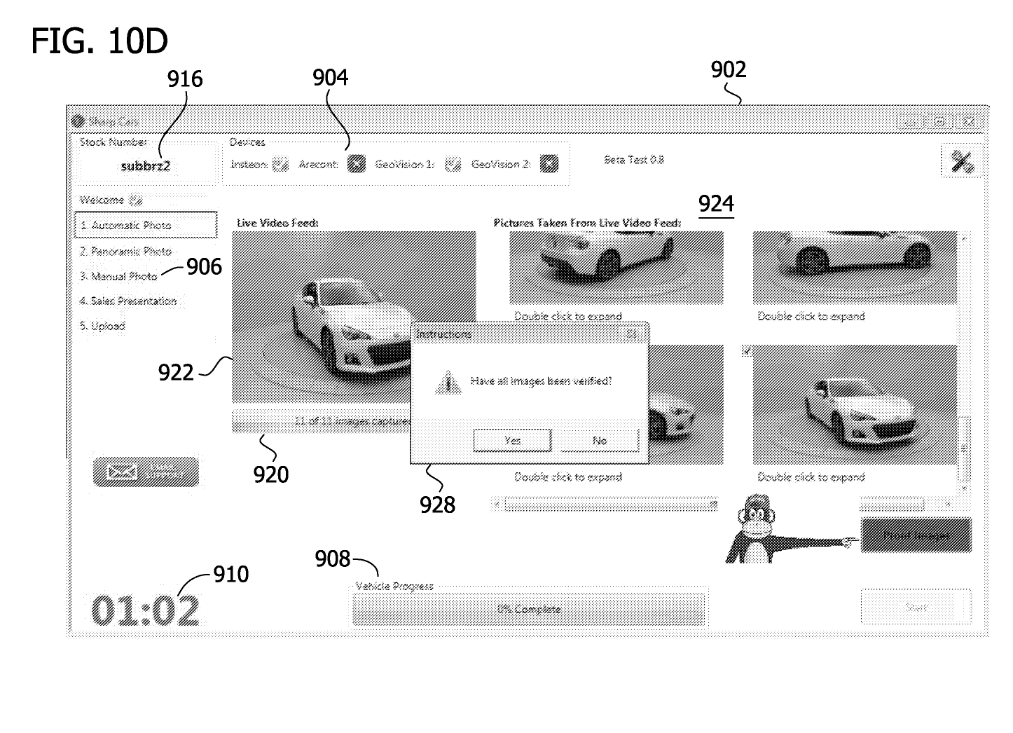

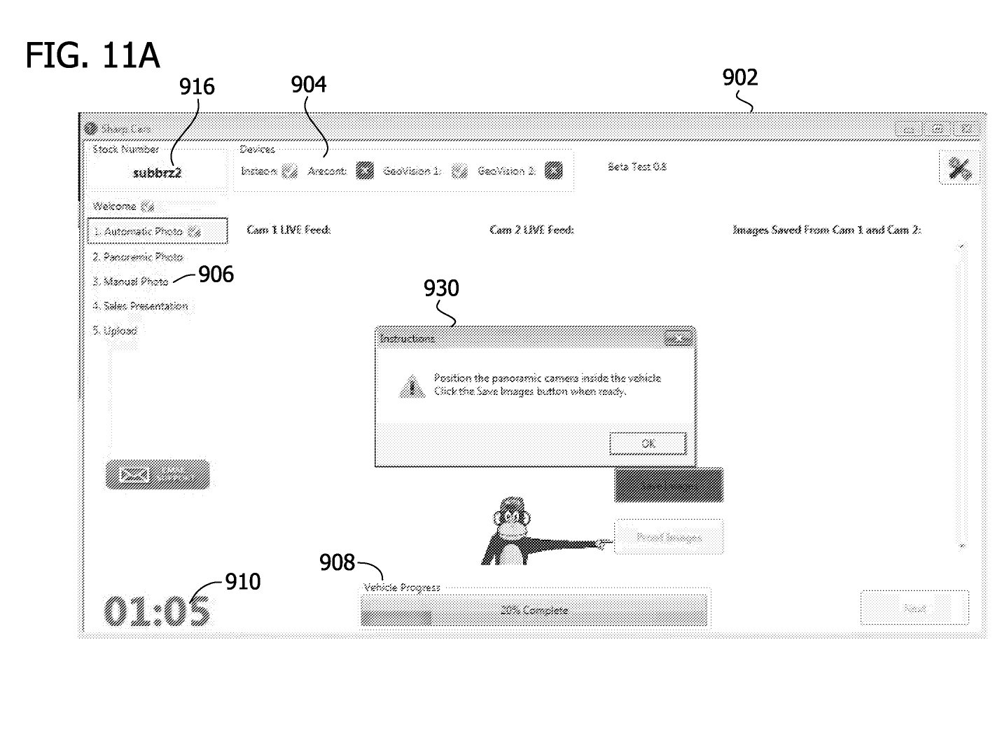

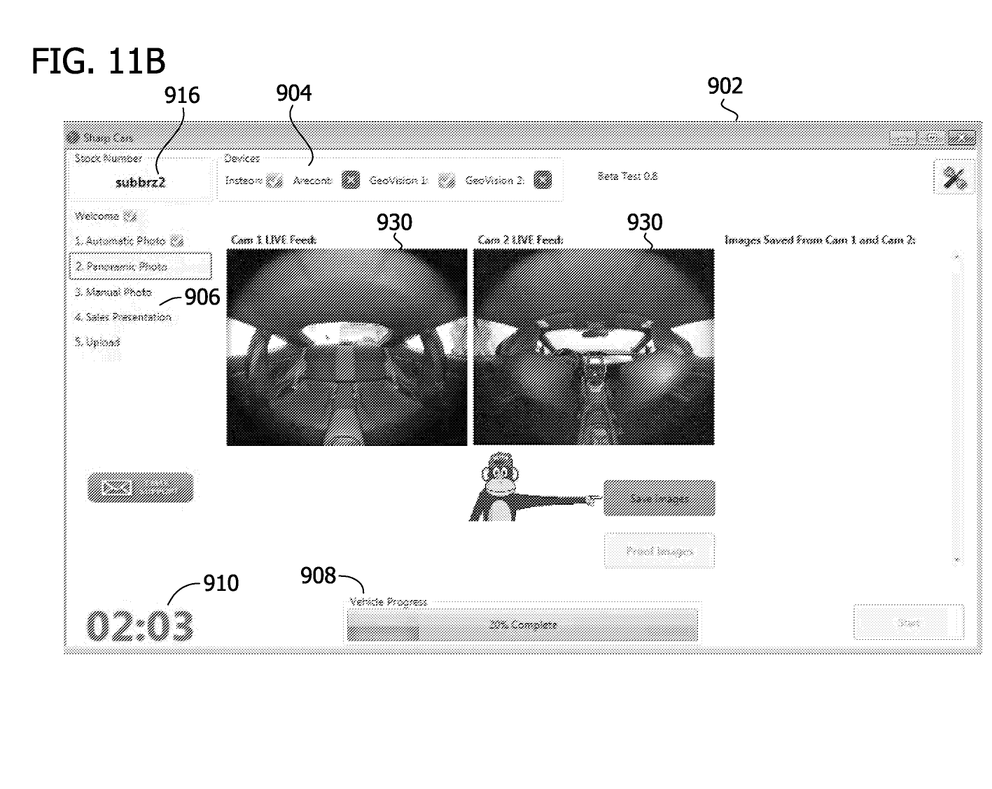

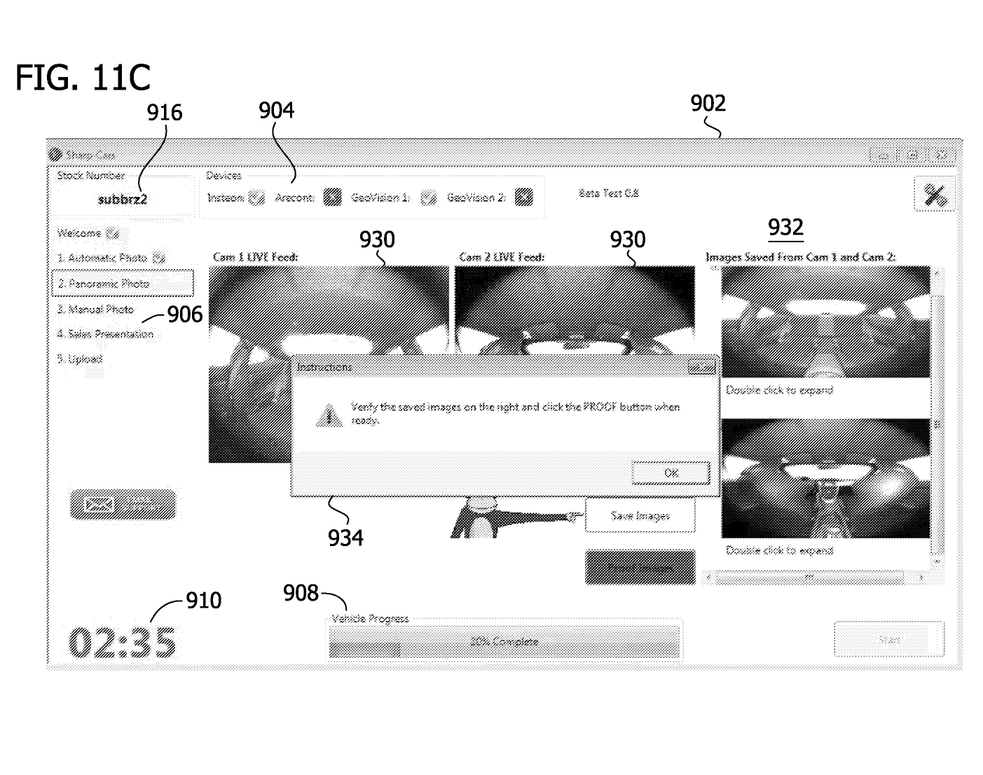

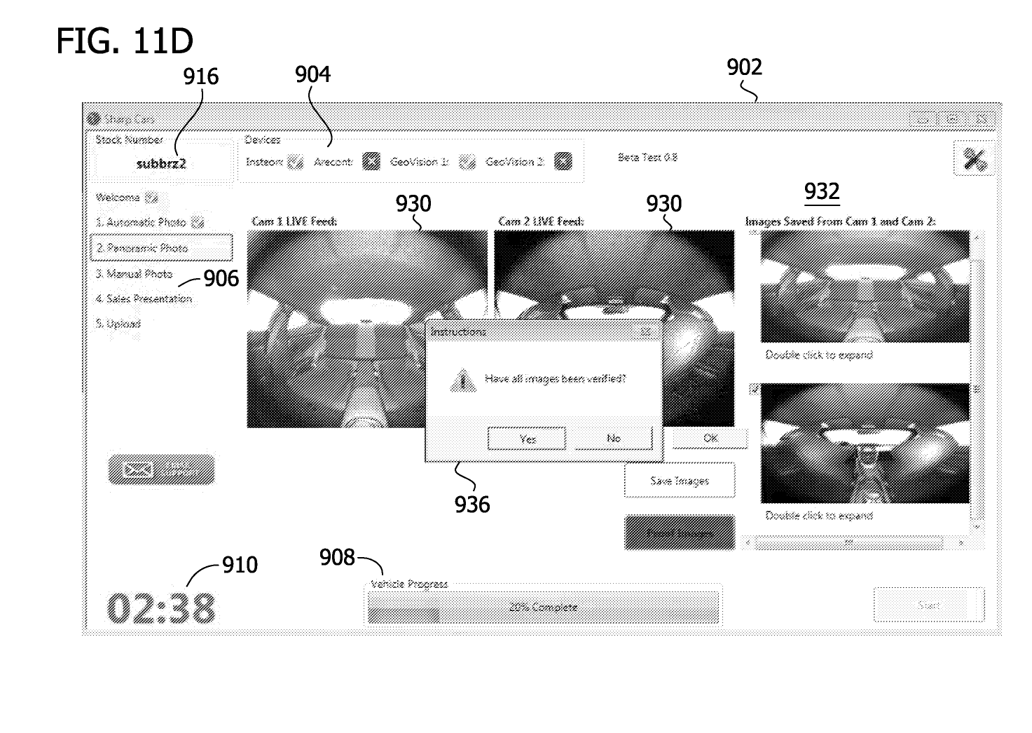

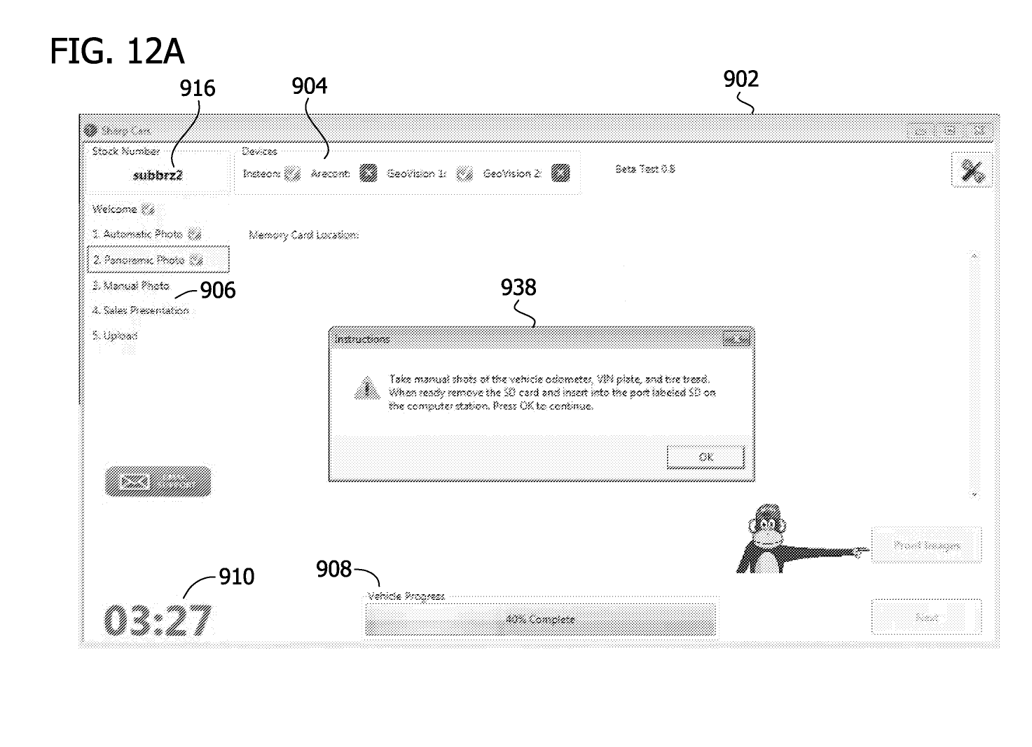

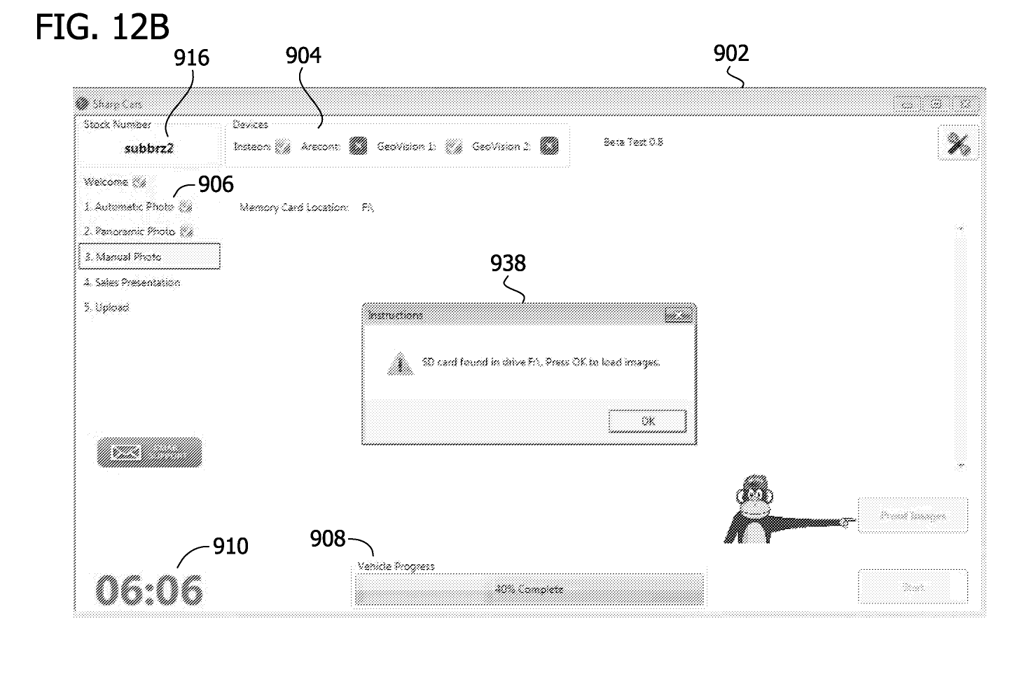

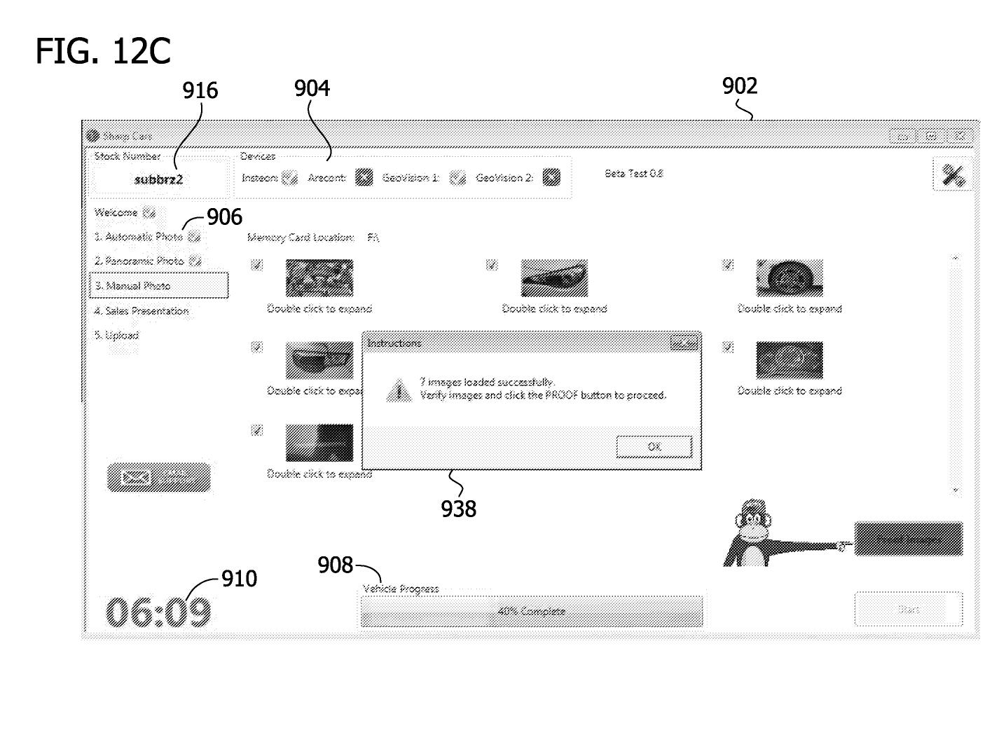

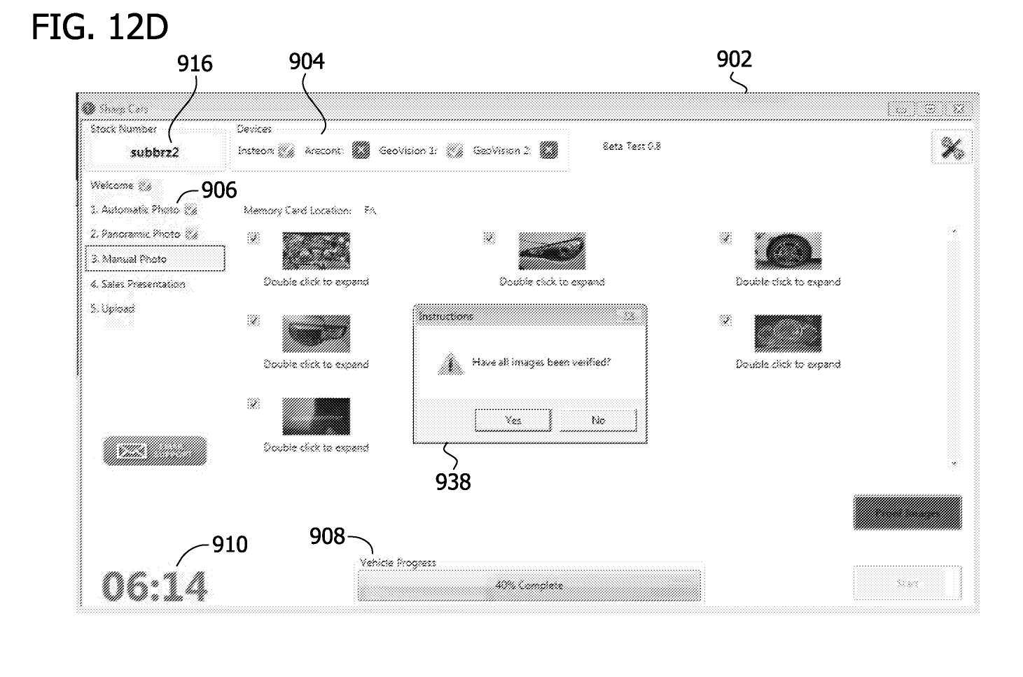

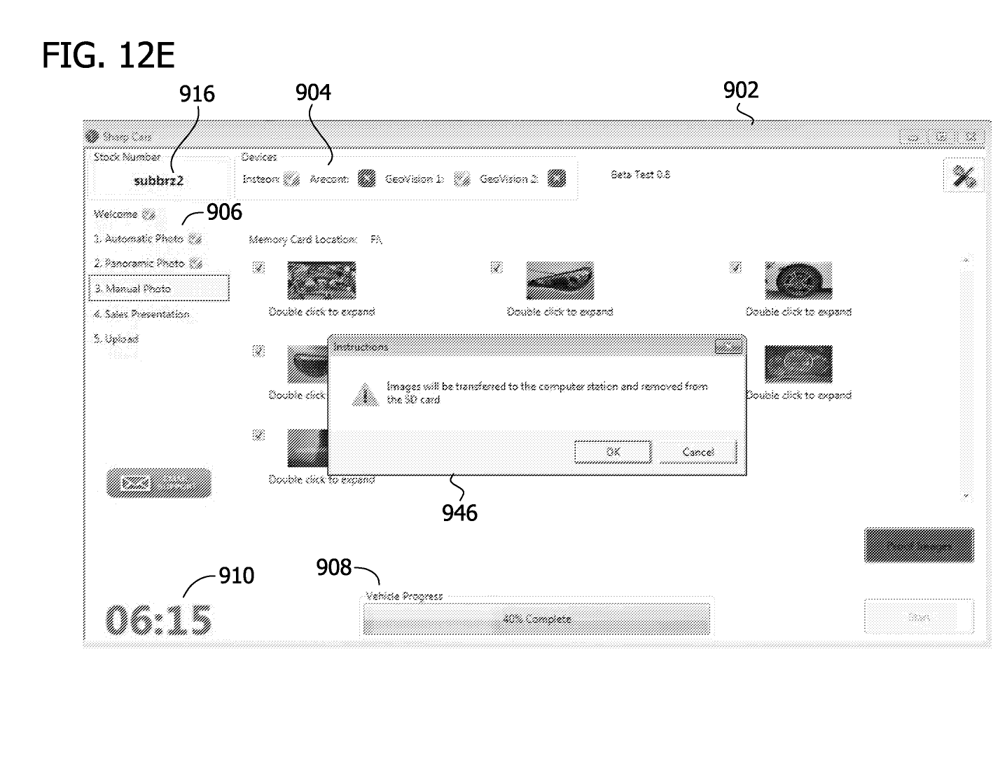

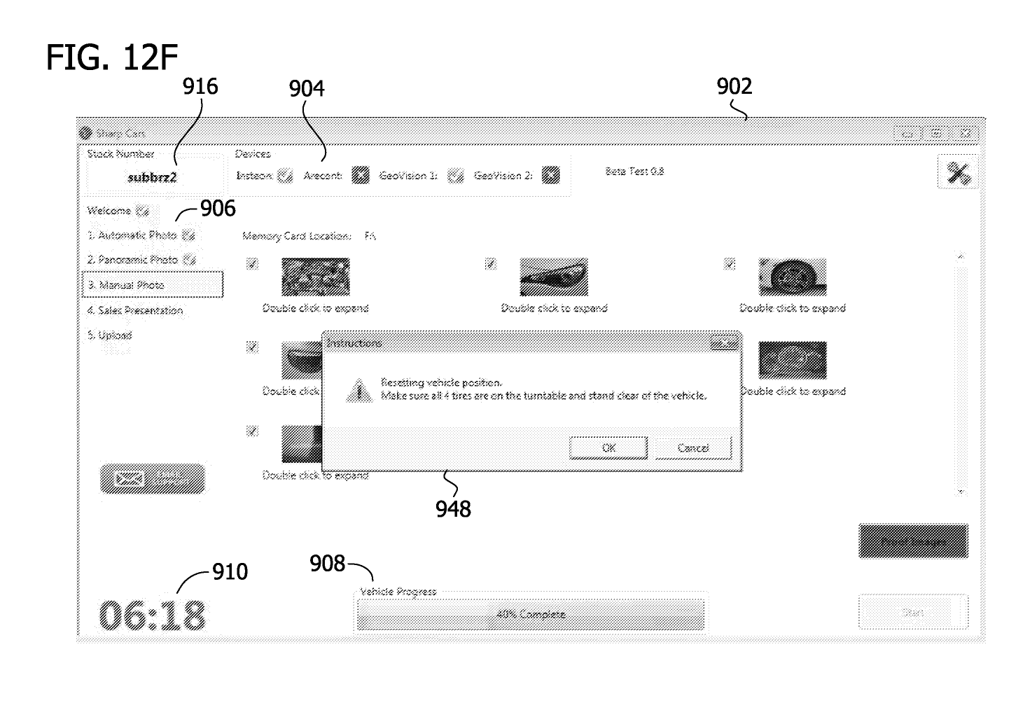

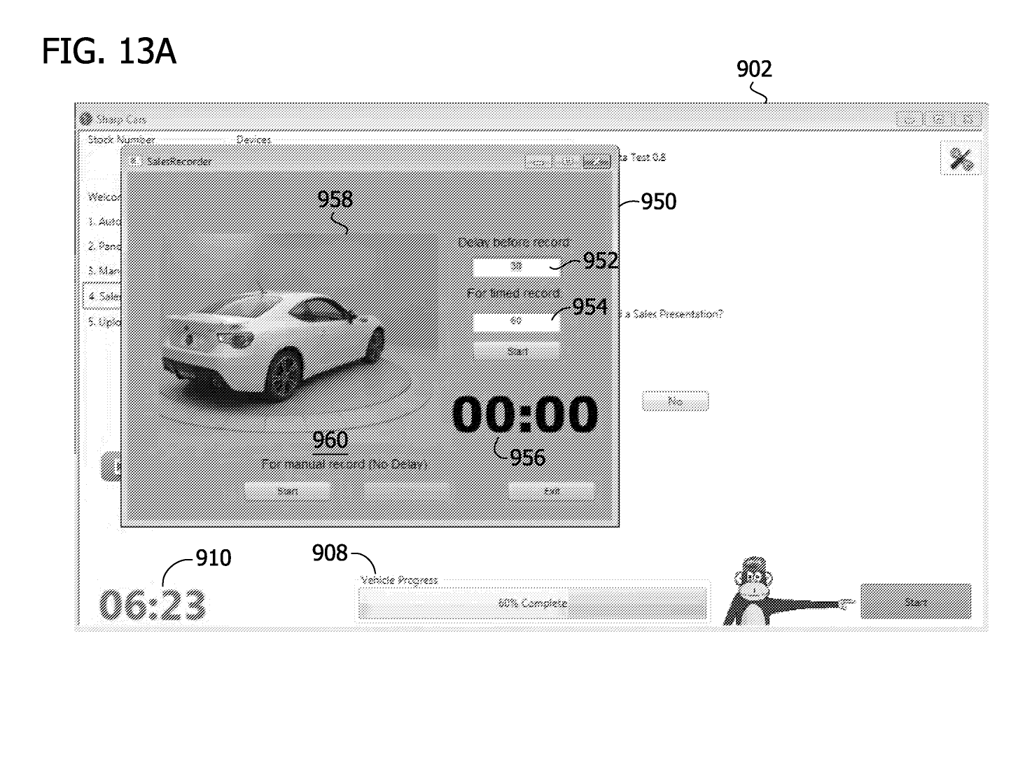

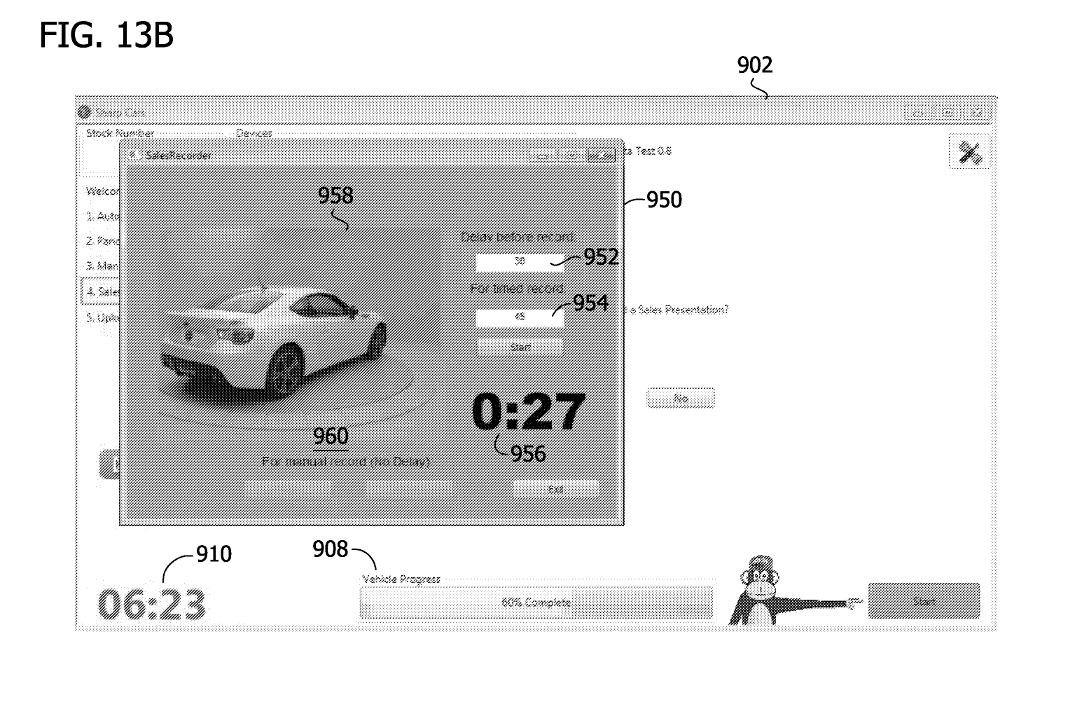

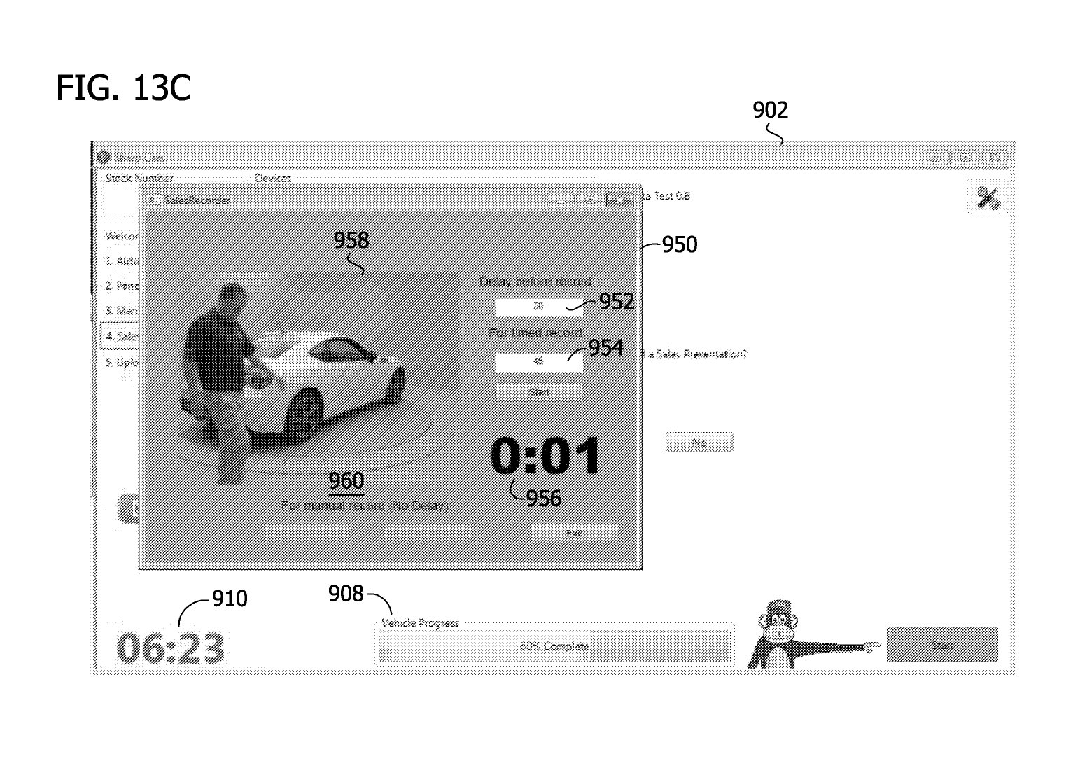

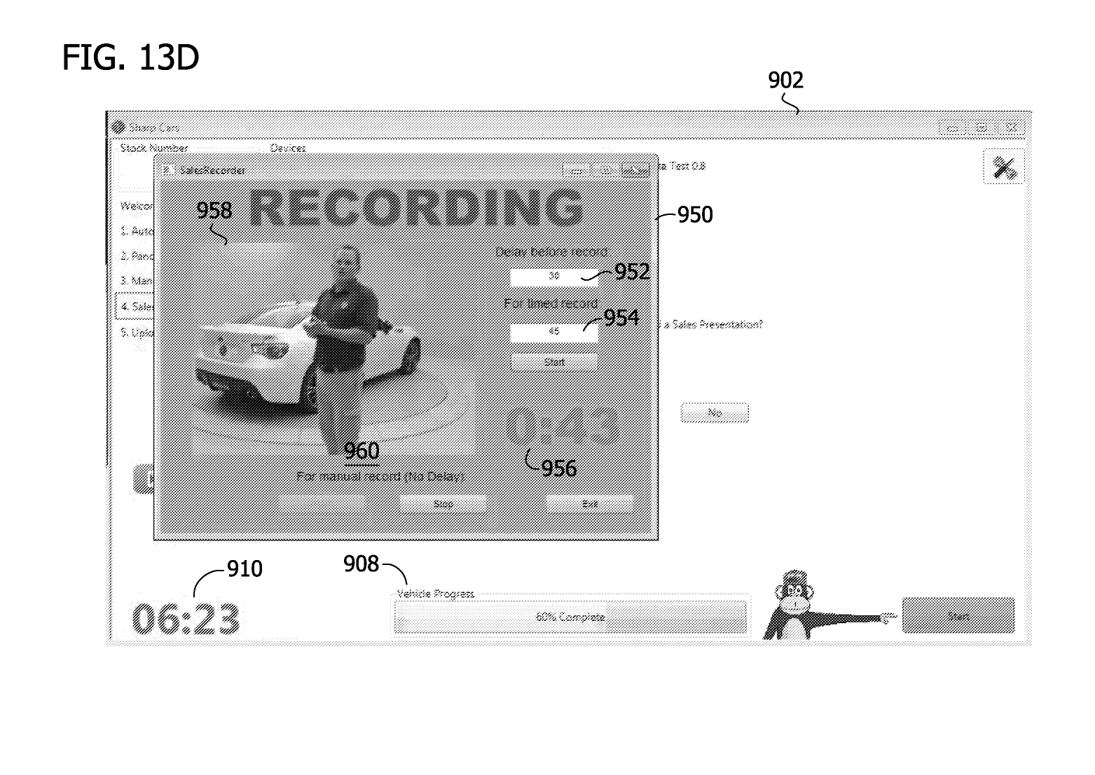

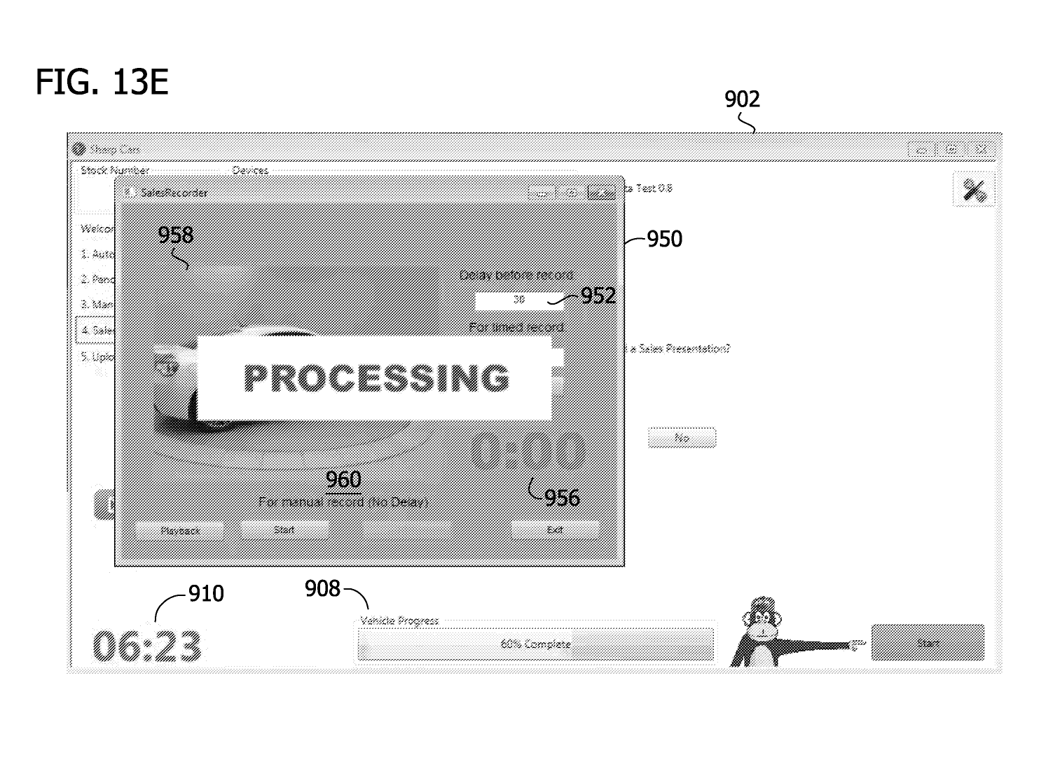

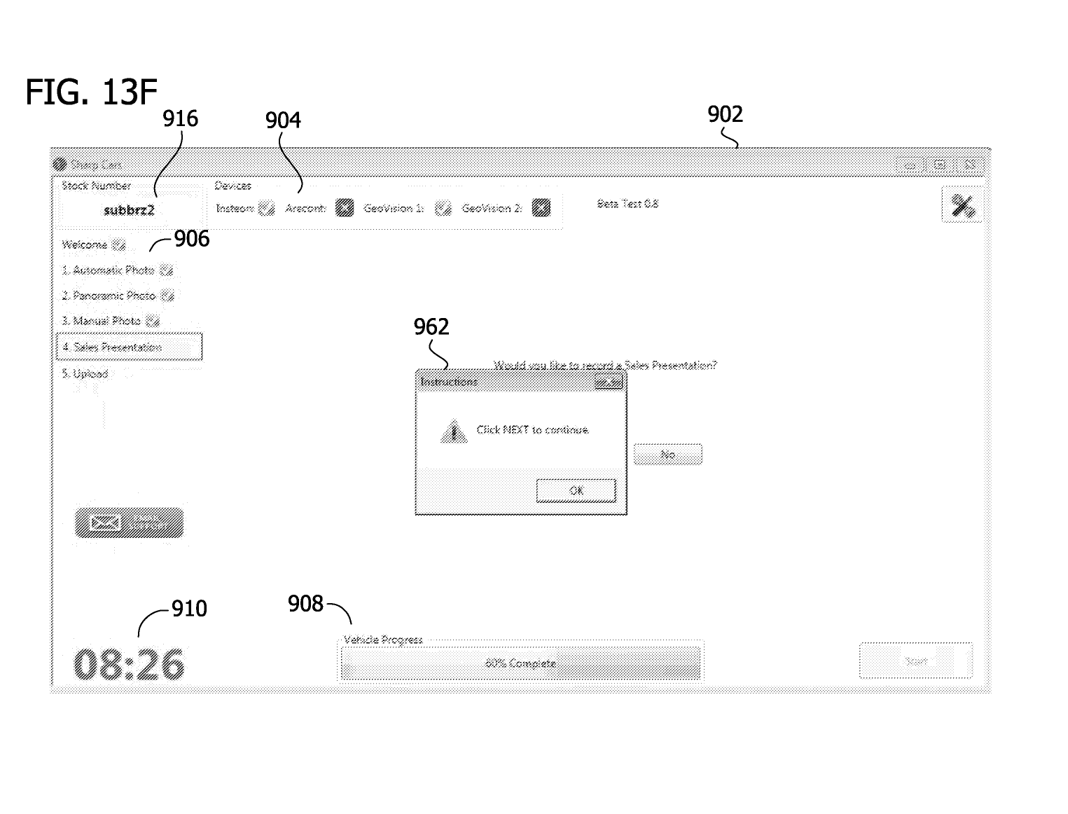

Referring further to the computer-readable instructions embodied in software executed by computer 103, automated studio 100 creates a simple user experience in which a wizard 902 guides a user through each step of the image acquisition and upload process. It is contemplated that certain steps of the image acquisition and upload process may be skipped. In an embodiment illustrated by FIG. 9a, user interface wizard 902 displays a welcome screen indicating information about the automated studio and capable of receiving information about the vehicle. As illustrated in FIG. 9a, the wizard indicates in area 904 the various devices, integration software, and control software presently connected to the automated studio. Further illustrated in FIG. 9a, wizard 902 displays in area 906 the steps of the image acquisition and upload process along with the current step, a process progress bar 908, a timer 910 for indicating the elapsed time of the process for the current vehicle, and text entry boxes 912 for manual entry of the VIN and the vehicle stock number. The VIN may also be populated into text entry box 912 through use of barcode scanner 508. FIG. 9b illustrates a VIN number and a vehicle stock number entered in text entry boxes 912. The user interface wizard 902 also displays on-screen warnings to help the user avoid common pitfalls. In an embodiment illustrated by FIG. 9c, user interface wizard 902 displays an on-screen warning 914 indicating that turntable 101 is not entirely supporting the vehicle because some of the vehicle's tires are not located upon turntable 101. It is also contemplated that on-screen warning 914 illustrated by FIG. 9c may be skipped if turntable 101 is not utilized.

In an embodiment illustrated by FIG. 10a, user interface wizard 902 displays a screen to facilitate the acquisition of images of the exterior of the vehicle. In this embodiment, the screen displays the vehicle stock number in area 916 along with process progress bar 908 and device connection information in area 904. Further, the screen of this embodiment displays a status signal 918 indicating whether automated studio 100 is acquiring images, a progress bar 920 for indicating the status of the exterior imaging process, a live video feed 922 of the vehicle being imaged, and acquired snap shot images 924 of the vehicle. The embodiment of FIG. 10b illustrates the exterior image acquisition screen further along in the exterior imaging process. The embodiment of FIG. 10c illustrates an on-screen instruction 926 that displays at the completion of the exterior imaging process for instructing the user to commence the image proofing process. The user may proof the acquired images for quality assurance purposes. The embodiment of FIG. 10d illustrates an on-screen instruction 928 that is displayed at the completion of the image proofing process for instructing the user to affirm that the images have been verified.

In an embodiment illustrated by FIG. 11a, user interface wizard 902 displays an on-screen instruction 930 for instructing the user to position interior imaging apparatus 500 inside the vehicle to acquire panoramic images. In an embodiment illustrated by FIG. 11b, user interface wizard 902 displays a screen to facilitate the acquisition of images of the interior of the vehicle. In this embodiment, the screen displays the vehicle stock number in area 916 along with process progress bar 908 and device connection information in area 904. Further, the screen of this embodiment displays a live video feed 930 from each camera of interior imaging apparatus 500. The embodiment of FIG. 11c illustrates the interior image acquisition screen displaying acquired snap shot images 932 of the interior of the vehicle and an on-screen instruction 934 that displays at the completion of the interior imaging process for instructing the user to commence the image proofing process. Again, the user may proof the acquired images for quality assurance purposes. The embodiment of FIG. 11d illustrates an on-screen instruction 936 that is displayed at the completion of the image proofing process for instructing the user to affirm that the images have been verified.

In an embodiment illustrated by FIG. 12a, user interface wizard 902 displays an on-screen instruction 938 for instructing the user to manually acquire images of certain portions of the vehicle and insert a portable memory device storing the images into computer 103. The embodiment of FIG. 12b illustrates user interface wizard 902 displaying an on-screen confirmation 940 that the user correctly inserted the memory device into the computer. The embodiment of FIG. 12c illustrates user interface wizard 902 displaying an on-screen confirmation 942 that the images on the memory device have been accessed by the computer. Upon confirmation of the accessing, the user commences the image proofing process for the manually acquired images for quality assurance purposes. The embodiment of FIG. 12d illustrates an on-screen instruction 944 that is displayed at the completion of the image proofing process for instructing the user to affirm that the images have been verified. The embodiment of FIG. 12e illustrates an on-screen instruction 946 for alerting the user that the automated studio will transfer the verified images from the inserted memory device to computer 103 and delete the images from the memory device. The embodiment of FIG. 12f illustrates an on-screen instruction 948 for alerting the user that turntable 101 is rotating the vehicle to the initial orientation it was in at the beginning of the image acquisition process.

In an embodiment illustrated by FIG. 13a, user interface wizard 902 displays a screen to facilitate the acquisition of a video “sales pitch” demonstrating the vehicle's features and options. In this embodiment, the wizard 902 displays a “sales pitch” acquisition window 950 in a secondary window. The “sales pitch” acquisition window 950 displays a text entry box 952 for the user to enter a desired period of time to delay the start of the video acquisition, a text entry box 954 for the user to enter a desired period of time to acquire the video, a timer 956, a live video feed 958 of the vehicle and salesperson, and an option area 960 to manually start and stop the video acquisition. The embodiment of FIG. 13b illustrates “sales pitch” acquisition window 950 during a delay period before video acquisition begins where timer 956 counts down from the entered time amount in text entry box 952. The embodiment of FIG. 13c further illustrates “sales pitch” acquisition window 950 during the delay period where a salesperson is able to enter the view of the video acquisition device as shown by live feed 958. The embodiment of FIG. 13d illustrates “sales pitch” acquisition window 950 during the video acquisition period with timer 956 indicating the amount of time remaining in the acquisition period. The embodiment of FIG. 13e illustrates “sales pitch” acquisition window 950 after the video acquisition period and where the acquired video is being processed. The embodiment of FIG. 13f illustrates an on-screen instruction 962 instructing the user to continue the process after the sales pitch has been acquired.

The acquired images (e.g., photographs and/or videos of the interior and/or exterior of the vehicle, with or without audio) may be stored on computer 103 alone, on server 104 alone, on computer 103 temporarily or indefinitely and also on server 104, or any combination thereof. Once the images are acquired, computer 103 executes software to inventory and compress them. For example, the software supports MPEG-4 video compression to greatly reduce data retention and transmission requirements. In an embodiment, the acquired images are superimposed on a stock photograph, such as a photograph of a dealership building.

In an embodiment illustrated by FIG. 14a, user interface wizard 902 displays a screen indicating that the acquired images and sales pitch videos are being uploaded to server 104 and processed to allow for browser or device detection. In this embodiment, the screen displays a progress bar 964 indicating the number of images already uploaded and the number remaining to be uploaded. In another embodiment, billing information is processed at this step for payment for use of the automated studio 100 or portions thereof. The embodiment of FIG. 14b illustrates an on-screen instruction 966 alerting the user that all images and videos have been successfully uploaded to server 104. It is to be understood that the processing of images to produce the panoramic and/or other views may be automated such that user input is not needed between image acquisition and posting of the finished images.

In addition, the software embodying aspects of the invention employs an integrated support model in which a full-featured logging system helps to track errors. Moreover, the software allows a technician to directly connect to a machine from anywhere to troubleshoot problems. Online tools give a user (e.g., the dealer or seller) the ability to track bugs, view development progress, and suggest new enhancements.

Advantageously, the software integrates well with third-party software. For example, the software integrates with Insteon HouseLinc relays, Arecont Vision IP Cameras, and GeoVision Fisheye IP cameras. The software transmits a signal that causes turntable 101 to rotate the vehicle and acquires, via cameras 102, individual photographs at a defined rate, once every second for example, as well as a video while the vehicle is rotating. In addition, the software transmits a signal that manipulates imaging apparatus 500 and causes fisheye cameras 502 to acquire a live panoramic snap shot. The software automatically detects external drives connected to computer 103 to acquire manually acquired images stored on the drive and transmits acquired images to server 104.

In another aspect, the software permits comprehensive data gathering. For example, a user interface prompts a user to enter identifying information about the vehicle, such as the Stock Number, VIN number, or any combination thereof for vehicle tracking. The software also creates data folders organized by various characteristics and automatically places the images into folders corresponding to each step of the process for easy location. The characteristics the software may use to organize data folders include, by way of example and not limitation, date, vehicle stock number, VIN number, vehicle color, vehicle make, vehicle model, vehicle type, or any combination thereof.

Customizable software settings allow specification of the IP address of IP cameras 102, 502 and customization of file storage locations for saving vehicle data. Also, the software settings permit the user to specify external storage drive information.

Embodiments of the present invention may comprise a special purpose or general purpose computer including a variety of computer hardware, as described in greater detail below.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage, or other magnetic storage devices, or any other medium that can be used to carry or store desired program code means in the form of computer-executable instructions or data structures and that can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

Referring to the embodiment of the invention in FIG. 1, server 104 hosts (e.g., stores and/or distributes) the acquired images for use by consumers or sellers via the Internet. The server 104 receives the acquired images from computer 103 and stores them on computer-readable media. The server may inventory, compress, stitch, or otherwise process the received images in addition to, or in the absence of, such actions by computer 103 or cameras 102, 502. A database 105 associated with server 104 stores the images along with metadata or other corresponding information relating to the images and/or vehicles themselves. The information contained in database 105 may be used with a website template stored on server 104 or an external server for showcasing the vehicles to consumers via a virtual showroom.

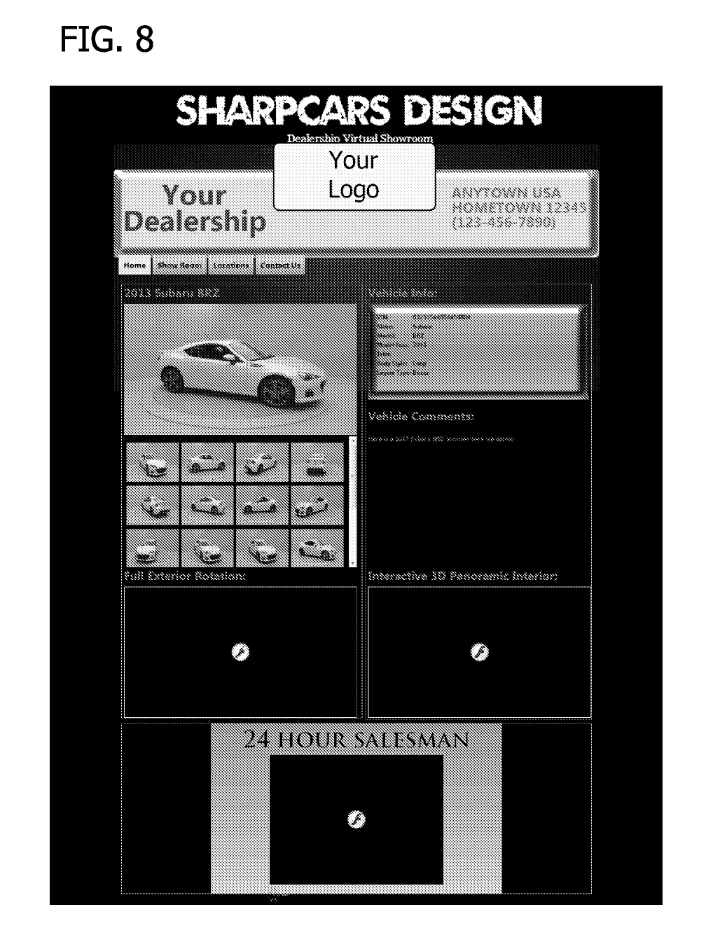

FIG. 8 illustrates an exemplary virtual showroom comprised of a website template and corresponding images. The information contained in database 105 may also be used with a website template stored on server 104 or an external server for managing of the vehicle inventory by a seller or dealer. In either case, the virtual showroom is comprised of the templates, images, and corresponding information and is accessible via the Internet.

Referring again to FIG. 1, server 104 connects to computer 103 via a communications channel. For example, a telecommunications network utilizing the Internet Protocol communications protocol, such as the Internet, or a communications channel employing serial and/or parallel communications methods. The server 104 receives the images and/or corresponding information from computer 103 via the communications channel and stores this content on computer-readable media, as described above, associated with server 104. In addition to content received from computer 103, in one embodiment of the invention, the stored content includes video and/or audio of a salesperson or the like explaining features of the vehicle. The server 104 may also inventory, compress, stitch, or otherwise process the images, as described above.

The database 105 is associated with server 104 for organizing the stored content. The database 105 may reside on server 104 or on an external computing device that is connected to server 104 via a communications channel. The database 105 is capable of using various standards, such as SQL, ODBC, and JDBC, for example. Exemplary database management systems (DBMS) include MySQL, Microsoft SQL Server, Oracle, and SAP. The database 105 contains the acquired images and may contain metadata and other corresponding information relating the images themselves. Moreover, database 105 may store information corresponding to the imaged vehicles themselves including, by way of example and not limitation, vehicle stock number, VIN number, vehicle color, vehicle make, vehicle model, vehicle type, or any combination thereof. The database 105 and the information it contains is accessible via the Internet, such as through the use of a web browser or an API.

In an embodiment, the information contained in database 105 is used with a website template stored on server 104 or an external server for showcasing the vehicles to consumers via a virtual showroom. Advantageously, the website template permits a developer to easily build a website from the hosted content to showcase vehicles. Through use of the template, aspects of the invention integrate with database 105 to dynamically populate customer and vehicle data for showcasing vehicle data that has been processed by server 104. The populated template consists of a homepage, a showroom page containing an entry for each vehicle, and a detailed vehicle page for each vehicle. The detailed vehicle pages display the acquired images of the vehicle along with the corresponding information relating to the images and/or the vehicle. Additionally, the detailed vehicle page is capable of providing the ability to display, on the page itself or in a pop-up window, a video of a salesperson or the like explaining features of the vehicle or a like video showcasing the vehicle. In this manner, aspects of the invention provide a virtual showroom. It is contemplated that the virtual showroom may be accessed via the consumer-side portal 106 from any computing device, including but not limited to personal computers, mobile devices, and tablet computing devices.

The following exemplary code provides buttons for displaying videos:

<li><a href=“#”
onclick=“javascript:window.open(‘http://sharpcarsmedia.com/buttons/
Ex.MOV’, ‘_blank’, ‘status=yes,top=0,left=0,width=640,height=
480’);”> <img src=“http://sharpcarsmedia.com/buttons/ex2.jpg”
alt=“” /> </a></li>
<li><a href=“#”
onclick=“javascript:window.open(‘http://sharpcarsmedia.com/buttons/
int.swf’, ‘_blank’, ‘status=yes,top=0,left=0,width=640,height=
480’);”> <img src=“http://sharpcarsmedia.com/buttons/pano2.jpg”
alt=“” /> </a></li>
<li><a href=“#”
onclick=“javascript:window.open(‘http://sharpcarsmedia.com/buttons/
pre.mov’, ‘_blank’, ‘status=yes,top=0,left=0,width=640,height=
480’);”> <img src=“http://sharpcarsmedia.com/buttons/242.jpg”
alt=“” /> </a></li>

When executed, the code pulls a graphic and a video from a server. In an embodiment, the information contained in database 105 is used with an administrator console 107 stored on server 104 or an external server for managing the vehicle inventory. Such an inventory management application advantageously allows for easily tracking the progress of a vehicle among the various stages of automated studio 100 (e.g., image acquisition, image processing, and inventory entry creation). For example, a dealer can execute administrator console 107 application remotely (e.g., via a web application) to provide an automated ticketing process for tracking vehicle progress. The administrator console 107 also provides metrics and reporting data and tracks vehicle, customer, and process information. In addition, administrator console 107 provides access to detailed logs and reporting to troubleshoot vehicle processing errors. The metadata and other corresponding information relating to the images and/or the vehicles permit a user to determine the location of image and video files.

Advantageously, the entire automated studio 100 can be operated remotely and permits complete integration from end-to-end, ensuring a centralized data repository. Moreover, the solution is scalable for future growth.

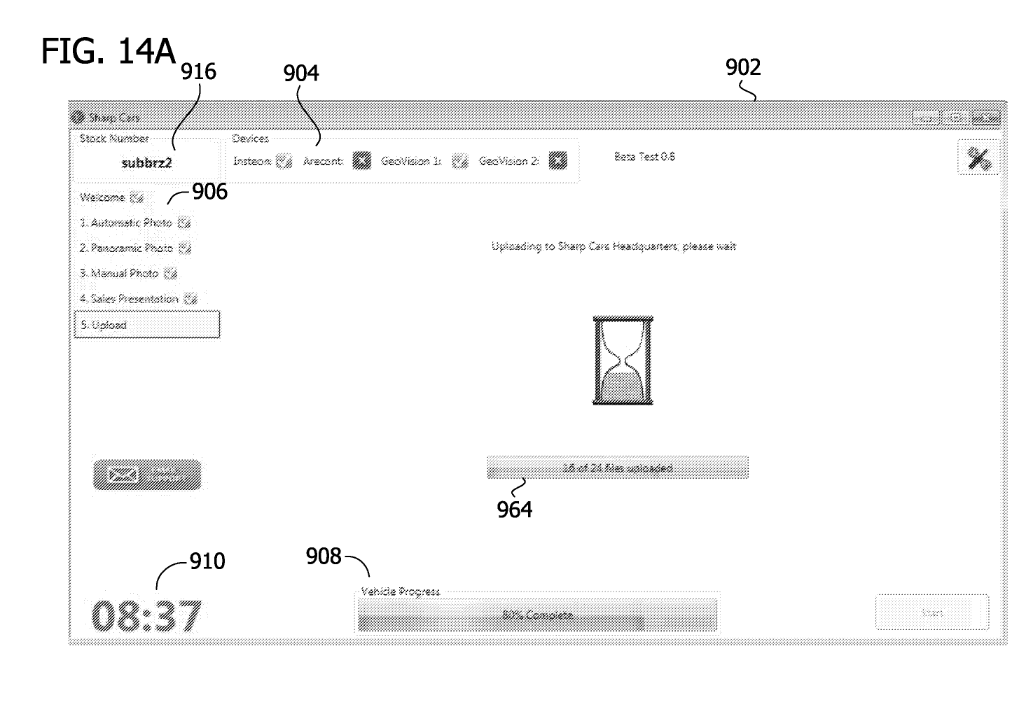

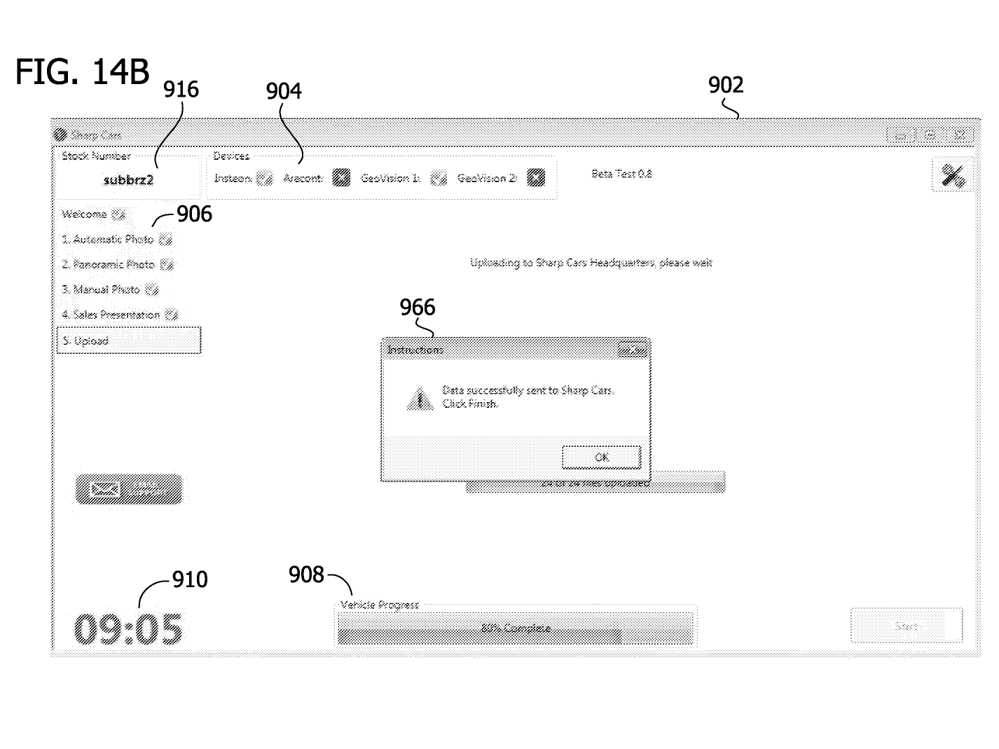

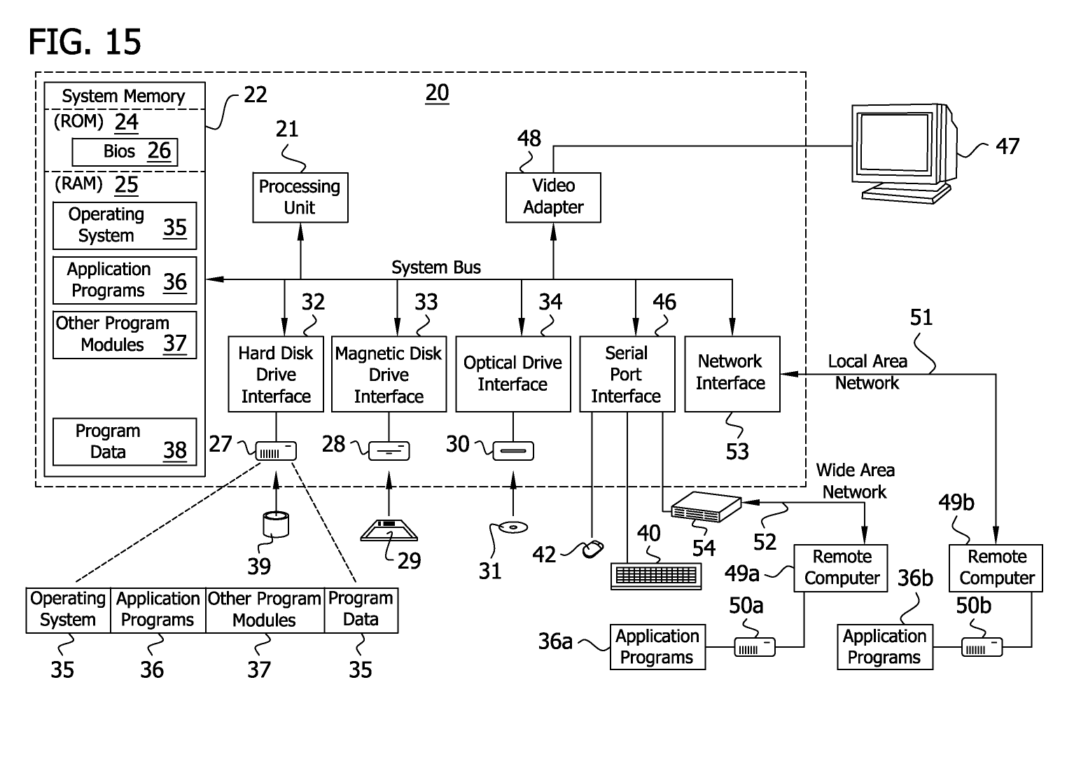

FIG. 15 and the following discussion are intended to provide a brief, general description of a suitable computing environment in which aspects of the invention may be implemented. Although not required, aspects of the invention will be described in the general context of computer-executable instructions, such as program modules, being executed by computers in network environments. Generally, program modules include routines, programs, objects, components, data structures, and the like that perform particular tasks or implement particular abstract data types. Computer-executable instructions, associated data structures, and program modules represent examples of the program code means for executing steps of the methods disclosed herein. The particular sequence of such executable instructions or associated data structures represent examples of corresponding acts for implementing the functions described in such steps.

Those skilled in the art will appreciate that aspects of the invention may be practiced in network computing environments with many types of computer system configurations, including personal computers, hand-held devices, mobile devices, multi-processor systems, microprocessor-based or programmable consumer electronics, network PCs, minicomputers, mainframe computers, and the like. Aspects of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 15, an exemplary system for implementing aspects of the invention includes a general purpose computing device in the form of a conventional computer 20, including a processing unit 21, a system memory 22, and a system bus 23 that couples various system components including the system memory 22 to the processing unit 21. The system bus 23 may be any of several types of bus structures including a memory bus or memory controller, a peripheral bus, and a local bus using any of a variety of bus architectures. The system memory includes read only memory (ROM) 24 and random access memory (RAM) 25. A basic input/output system (BIOS) 26, containing the basic routines that help transfer information between elements within the computer 20, such as during start-up, may be stored in ROM 24. Further, the computer 20 may include any device (e.g., computer, laptop, tablet, PDA, cell phone, mobile phone, smart television, and the like) that is capable of receiving or transmitting an IP address wirelessly to or from the Internet.

The computer 20 may also include a magnetic hard disk drive 27 for reading from and writing to a magnetic hard disk 39, a magnetic disk drive 28 for reading from or writing to a removable magnetic disk 29, and an optical disk drive 30 for reading from or writing to removable optical disk 31 such as a CD-ROM or other optical media. The magnetic hard disk drive 27, magnetic disk drive 28, and optical disk drive 30 are connected to the system bus 23 by a hard disk drive interface 32, a magnetic disk drive-interface 33, and an optical drive interface 34, respectively. The drives and their associated computer-readable media provide nonvolatile storage of computer-executable instructions, data structures, program modules, and other data for the computer 20. Although the exemplary environment described herein employs a magnetic hard disk 39, a removable magnetic disk 29, and a removable optical disk 31, other types of computer readable media for storing data can be used, including magnetic cassettes, solid-state drives, flash memory cards, digital video disks, Bernoulli cartridges, RAMs, ROMs, and the like.

Computer 20 typically includes a variety of computer readable media. Computer readable media can be any available media that can be accessed by computer 20 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media is non-transitory and includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired non-transitory information, which can accessed by computer 20. Alternatively, communication media typically embodies computer readable instructions, data structures, program modules or other data in a modulated data signal such as a carrier wave or other transport mechanism and includes any information delivery media.

Program code means comprising one or more program modules may be stored on the hard disk 39, magnetic disk 29, optical disk 31, ROM 24, and/or RAM 25, including an operating system 35, one or more application programs 36, other program modules 37, and program data 38. A user may enter commands and information into the computer 20 through keyboard 40, pointing device 42, or other input devices (not shown), such as a microphone, joy stick, game pad, satellite dish, scanner, or the like. These and other input devices are often connected to the processing unit 21 through a serial port interface 46 coupled to system bus 23. Alternatively, the input devices may be connected by other interfaces, such as a parallel port, a game port, or a universal serial bus (USB). A monitor 47 or another display device is also connected to system bus 23 via an interface, such as video adapter 48. In addition to the monitor, personal computers typically include other peripheral output devices (not shown), such as speakers and printers.

One or more aspects of the invention may be embodied in computer-executable instructions (i.e., software), routines, or functions stored in system memory 26 or non-volatile memory 27, 29, 31 as application programs 36, program modules 37 and/or program data 35, 38. The software may alternatively be stored remotely, such as on remote computer 49a, 49b with remote application programs 36a, 36b. Generally, program modules include routines, programs, objects, components, data structures, etc. that perform particular tasks or implement particular abstract data types when executed by a processor in a computer or other device. The computer executable instructions may be stored on a computer readable medium such as a hard disk 27, 39, optical disk 31, removable storage media 29, solid state memory, RAM 25, etc. As will be appreciated by one of skill in the art, the functionality of the program modules may be combined or distributed as desired in various embodiments. In addition, the functionality may be embodied in whole or in part in firmware or hardware equivalents such as integrated circuits, application specific integrated circuits, field programmable gate arrays (FPGA), and the like.

The computer 20 may operate in a networked environment using logical connections to one or more remote computers, such as remote computers 49a and 49b. Remote computers 49a and 49b may each be another personal computer, a tablet, a PDA, a server, a router, a network PC, a peer device or other common network node, and typically include many or all of the elements described above relative to the computer 20, although only memory storage devices 50a and 50b and their associated application programs 36a and 36b have been illustrated in FIG. 9. The logical connections depicted in FIG. 9 include a local area network (LAN) 51 and a wide area network (WAN) 52 that are presented here by way of example and not limitation. Such networking environments are commonplace in office-wide or enterprise-wide computer networks, intranets and the Internet.

When used in a LAN networking environment, the computer 20 is connected to the local network 51 through a network interface or adapter 53. When used in a WAN networking environment, the computer 20 may include a modem 54, a wireless link, or other means for establishing communications over the wide area network 52, such as the Internet. The modem 54, which may be internal or external, is connected to the system bus 23 via the serial port interface 46. In a networked environment, program modules depicted relative to the computer 20, or portions thereof, may be stored in the remote memory storage device. It will be appreciated that the network connections shown are exemplary and other means of establishing communications over wide area network 52 may be used.

Preferably, computer-executable instructions are stored in a memory, such as hard disk drive 27, and executed by computer 20. Advantageously, the computer processor has the capability to perform all operations (e.g., execute computer-executable instructions) in real-time.

A system embodying aspects of the invention permits rendering a virtual vehicle showroom. In one embodiment, the system includes turntable 101 adapted for receiving a vehicle on its rotatable platform. At least one camera 102 (e.g., an Internet protocol camera) acquires one or more images of the vehicle and database 105 stores the acquired images and corresponding information. A computer, such as computer 103, executes computer-executable instructions for rendering a virtual showroom user interface for presenting the acquired images and the corresponding information. In an embodiment, another computer communicatively connected to the turntable and the camera executes computer-executable instructions for displaying a systematic procedure for acquiring the one or more images, receiving commands for acquiring the one or more images, and executing the received commands to manipulate the camera and turntable to acquire the one or more images. In addition, this second computer executes computer-executable instructions for automatically stitching at least two of the acquired images together as well as compressing the acquired images.

The virtual showroom user interface preferably comprises a website template for integrating with the database 105 to populate the template with the acquired images and the corresponding vehicle information. And the database further logs metrics and reporting data.

In operation, a method for rendering a virtual vehicle showroom embodying aspects of the invention comprises acquiring one or more images of a vehicle while the vehicle is present upon a turntable having a rotatable platform for supporting the vehicle, storing the acquired images and corresponding information in a database, and executing computer-executable instructions for rendering a virtual showroom user interface for presenting the acquired images and the corresponding information. The method further comprises displaying a systematic procedure for acquiring the one or more images, receiving commands for acquiring the one or more images, and executing the received commands to acquire the one or more images. In yet another embodiment, the method includes automatically stitching at least two of the acquired images together, compressing the acquired images, populating a website template with the acquired images and the corresponding information by the virtual showroom interface, and/or logging metrics and reporting data.

A system for acquiring images for rendering a virtual vehicle showroom embodies further aspects of the invention. Such system comprises mobile cart 505, which has support arm 501 extending from it. The linear motion member 504 on the cart manipulates the position of the support arm. In addition, the system includes cameras 502 mounted on the support arm and at least one wireless communications transceiver on the cart for transmitting images acquired by the cameras and for receiving control communications. In an embodiment, the support arm is sized and shaped to enable positioning within an interior of a vehicle. An electrical power source, such as a battery, on the cart provides power to the various components. In yet another embodiment, at least one light source 503 on the support arm illuminates the area for improved imaging. Advantageously, the system further includes a barcode scanner for acquiring, for example, the vehicle's VIN. It is to be understood that the mobile imaging system described here may be used separately or together with turntable 101 and camera 102.

In an embodiment, the system further includes the database for storing the acquired images and corresponding information and a computer executing computer-executable instructions for rendering a virtual showroom user interface for presenting the acquired images and the corresponding information. The virtual showroom user interface comprises a website template for integrating with the database to populate the template with the acquired images and corresponding information. A second computer, preferably communicatively connected to the cart, executes computer-executable instructions for displaying a systematic procedure for acquiring the one or more images, receiving commands for acquiring the one or more images, and executing the received commands to manipulate the cart to acquire the one or more images.

Another system for rendering a virtual vehicle showroom embodying aspects of the invention comprises a mobile cart having a plurality of cameras for acquiring one or more images of a vehicle, an electrical power source, and at least one wireless communications transceiver (e.g., a modem or another computer). In addition, the system includes a database for storing the acquired images and corresponding information and a computer executing computer-executable instructions for rendering a virtual showroom user interface for presenting the acquired images and the corresponding information. A light source and an electrical power source, such as a battery, and a barcode scanner may also be affixed to the cart. It is to be understood that the mobile imaging system described here may be used separately or together with turntable 101 and camera 102. A second computer communicatively connected to the cart executes computer-executable instructions for displaying a systematic procedure for acquiring the one or more images, receiving commands for acquiring the one or more images, and executing the received commands to manipulate the cart to acquire the one or more images. In an embodiment, the virtual showroom user interface comprises a website template for integrating with the database to populate the template with the acquired images and corresponding information and the database preferably logs metrics and reporting data.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Embodiments of the invention may be implemented with computer-executable instructions. The computer-executable instructions may be organized into one or more computer-executable components or modules. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A system for rendering a virtual vehicle showroom comprising:
a turntable adapted for receiving a vehicle, said turntable having a rotatable platform for supporting the received vehicle;
at least one camera for acquiring one or more images of the vehicle;
a database for storing the acquired images and corresponding information; and
a computer executing computer-executable instructions for rendering a virtual showroom user interface for presenting the acquired images and the corresponding information.

2. The system of claim 1 further comprising a second computer executing computer-executable instructions, wherein the second computer is communicatively connected to the turntable and the camera.

3. The system of claim 2, wherein the second computer executes computer-executable instructions for:
displaying a systematic procedure for acquiring the one or more images;
receiving commands for acquiring the one or more images; and
executing the received commands to manipulate the camera and turntable to acquire the one or more images.

4. The system of claim 2, wherein the second computer executes computer-executable instructions for automatically stitching at least two of the acquired images together.

5. The system of claim 2, wherein the second computer executes computer-executable instructions for compressing the acquired images.

6. The system of claim 1, wherein the at least one camera is an Internet protocol camera.

7. The system of claim 1, wherein the virtual showroom user interface comprises a website template for integrating with the database to populate the template with the acquired images and the corresponding vehicle information.

8. The system of claim 1, wherein the database further logs metrics and reporting data.

9. A system for acquiring images for rendering a virtual vehicle showroom comprising:
a mobile cart;
a support arm extending from the cart;
a linear motion member on the cart for manipulating the support arm;
a plurality of cameras mounted on the support arm; and
at least one wireless communications transceiver on the cart for transmitting images acquired by the cameras and for receiving control communications.

10. The system of claim 9, wherein the support arm is sized and shaped to enable positioning within an interior of a vehicle.

11. The system of claim 9 further comprising an electrical power source on the cart for supplying electrical power to the system.

12. The system of claim 9 further comprising at least one light source mounted on the support arm.

13. The system of claim 9 further comprising a barcode scanner.

14. The system of claim 9 further comprising a turntable adapted for receiving a vehicle, said turntable having a rotatable platform for supporting the received vehicle.

15. The system of claim 9 further comprising:
a database for storing images acquired by the cameras and corresponding information; and
a computer executing computer-executable instructions for rendering a virtual showroom user interface for presenting the acquired images and the corresponding information.

16. The system of claim 15, wherein the virtual showroom user interface comprises a website template for integrating with the database to populate the template with the acquired images and corresponding information.

17. The system of claim 15, wherein the database further logs metrics and reporting data.

18. The system of claim 9 further comprising a computer executing computer-executable instructions for:
displaying a systematic procedure for acquiring one or more images from the cameras;
receiving commands for acquiring the one or more images; and
executing the received commands to manipulate the cart to acquire the one or more images.

19. A system for rendering a virtual vehicle showroom comprising:
a mobile cart having a plurality of cameras affixed thereon for acquiring one or more images of a vehicle, an electrical power source, and at least one wireless communications transceiver;
a database for storing the acquired images and corresponding information; and
a computer executing computer-executable instructions for rendering a virtual showroom user interface for presenting the acquired images and the corresponding information.

20. The system of claim 19 further comprising a light source mounted on the cart.

21. The system of claim 19 further comprising a turntable adapted for receiving the vehicle, said turntable having a rotatable platform for supporting the received vehicle.

22. The system of claim 19 further comprising a second computer executing computer-executable instructions for:
displaying a systematic procedure for acquiring the one or more images;
receiving commands for acquiring the one or more images; and
executing the received commands to manipulate the self-locomotive cart to acquire the one or more images.

23. The system of claim 19, wherein the virtual showroom user interface comprises a website template for integrating with the database to populate the template with the acquired images and corresponding information.
